(19) United States
(12) Patent Application Publication
(10) Pub. No.: US 2025/0377675 A1
(43) Pub. Date: Dec. 11, 2025

(54) CONTROL DEVICE

(71) Applicant: CANON KABUSHIKI KAISHA, Tokyo (JP)

(72) Inventor: KENICHI KATAOKA, Kanagawa (JP)

(21) Appl. No.: 19/225,557

(22) Filed: Jun. 2, 2025

(30) Foreign Application Priority Data
Jun. 5, 2024 (JP) 2024-091431

(51) Int. Cl. G05D 19/02; B06B 1/02; B06B 1/06; G05B 13/02

(52) U.S. Cl. CPC G05D 19/02; B06B 1/0207; B06B 1/0662; G05B 13/027

(57) ABSTRACT

A control device for a vibration-type actuator including a vibrating body and a contact body, the contact body being moveable relative to the vibrating body by vibration excited by applying an alternating-current voltage includes a neural network including an input layer which receives, as inputs, a detected value and at least one of a command value for a relative speed of the contact body with respect to the vibrating body and a command value for a thrust occurring between the vibrating body and the contact body, an intermediate layer which performs an arithmetic operation according to a signal received from the input layer, and an output layer which outputs a command for a manipulated variable for the alternating-current voltage, wherein the detected value is a detected value of a signal related to the alternating-current voltage or a detected value of vibration of the vibrating body.

### BACKGROUND

### Field

Aspects of the present disclosure generally relate to a control device.

### Description of the Related Art

A technique has been proposed which quickly and accurately controls the speed of a vibration-type actuator based on various state quantities of the vibration-type actuator using a neural network.

IEEE Ind. Appl. Conf. IAS 41, p. 2488, 2006, “Sensorless Speed Control of Traveling Wave Ultrasonic Motor” (hereinafter referred to as “Non-patent Literature 1”) discusses a technique which controls speeds by estimating the speed of a vibration-type actuator based on the frequency of a driving voltage, a current flowing through the vibration-type actuator, and a load torque of the vibration-type actuator using a neural network.

Japanese Patent Application Laid-Open No. 2023-63179 (hereinafter referred to as “Patent Literature 1”) discusses a technique which inputs, into a neural network, state quantities such as a target speed, a speed, a load torque, and a temperature and, moreover, manipulated variables such as a phase difference and frequency of a driving voltage and thus controls manipulated variables for a driving voltage.

Non-patent Literature 1 discusses a speed estimation technique using a neural network.

The speed estimation technique estimates speeds with use of a drive frequency, which is a parameter for controlling the speed of a vibration-type actuator, and a current flowing according to the vibration of the vibration-type actuator and, moreover, the detected value of a load torque, manipulates the drive frequency according to a difference between a target speed and an estimated speed, and thus controls speeds.

Since a load torque is used for such estimation, a torque sensor is required in addition to a current detection unit, so that it is difficult to miniaturize a vibration-type actuator.

Moreover, in the technique discussed in Patent Literature 1, since a speed sensor is used to control speeds, the speed sensor is required, so that it is also difficult to miniaturize a vibration-type actuator.

### SUMMARY

Aspects of the present disclosure are generally directed to enabling controlling a vibration-type actuator without use of a speed detecting sensor and a thrust (torque) detecting sensor.

According to an aspect of the present disclosure, a control device for a vibration-type actuator including a vibrating body, which includes an elastic body and an electro-mechanical energy conversion element, and a contact body, which is in contact with the elastic body, the contact body being moveable relative to the vibrating body by vibration of the vibrating body which is excited by applying an alternating-current voltage to the electro-mechanical energy conversion element, is provided, wherein the control device includes a neural network including an input layer which receives, as inputs, a detected value and at least one of a command value for a relative speed of the contact body with respect to the vibrating body and a command value for a thrust occurring between the vibrating body and the contact body, an intermediate layer which performs an arithmetic operation according to a signal received from the input layer, and an output layer which outputs a command for a manipulated variable for the alternating-current voltage, wherein the detected value is a detected value of a signal related to the alternating-current voltage or a detected value of vibration of the vibrating body.

Further features of the present disclosure will become apparent from the following description of exemplary embodiments with reference to the attached drawings.

### BRIEF DESCRIPTION OF THE DRAWINGS

FIGS. 1A, 1B, 1C, 1D, and 1E are diagrams illustrating examples of an outline configuration and a vibration shape of a vibration-type actuator.

FIG. 2 is a diagram illustrating a configuration example of a drive device for the vibration-type actuator.

FIGS. 3A and 3B are diagrams each illustrating a relationship between the speed of the vibration-type actuator and “the amplitude of a current signal IA−the amplitude of a current signal 1B”.

FIGS. 4A and 4B are diagrams each illustrating a relationship between the thrust of the vibration-type actuator and “the amplitude of a current signal IA−the amplitude of a current signal 1B”.

FIG. 5 is a diagram illustrating a configuration example of a device which is used for a neural network to perform learning.

FIG. 6 is a diagram illustrating a configuration example of a drive device for the vibration-type actuator.

FIG. 7 is a diagram illustrating a configuration example of a drive device for the vibration-type actuator.

FIGS. 8A and 8B are diagrams each illustrating a configuration example of a drive device for the vibration-type actuator.

FIGS. 9A, 9B, 9C, 9D, and 9E are diagrams illustrating examples of a configuration of a neural network.

FIG. 10 is a diagram illustrating a configuration example of a device which is used for a neural network to perform learning.

FIG. 11 is a diagram illustrating an example of an operation pattern for a learning operation of a neural network.

FIG. 12 is a diagram illustrating an example of an operation pattern for a learning operation of a neural network.

FIGS. 13A, 13B, and 13C are diagrams each illustrating an example of time history data which is used for a learning operation of a neural network.

FIG. 14 is a diagram illustrating a configuration example of a drive device for the vibration-type actuator.

FIGS. 15A and 15B are flowcharts each illustrating an operation for controlling a thrust and the amplitude of “a current signal IA+a current signal IB”.

FIGS. 16A, 16B, 16C, and 16D are diagrams illustrating examples of an outline configuration and a vibration shape of a vibration-type actuator.

FIGS. 17A, 17B, 17C, and 17D are diagrams illustrating examples of an outline configuration and a vibration shape of a vibration-type actuator.

FIGS. 18A and 18B are diagrams illustrating an example of an outline configuration of a vibration-type actuator.

FIG. 19 is a diagram illustrating a configuration example of a drive device for the vibration-type actuator.

FIGS. 20A and 20B are diagrams illustrating examples of alternating-current signal waveforms and a VB voltage amplitude command waveform.

FIG. 21 is a diagram illustrating a configuration example of a vibration-type actuator.

FIG. 22 is a diagram illustrating a configuration example of a drive device for the vibration-type actuator.

FIGS. 23A, 23B, and 23C are diagrams illustrating a configuration example of a vibration-type actuator.

FIG. 24 is a diagram illustrating a configuration example of a drive device for the vibration-type actuator.

### DESCRIPTION OF THE EMBODIMENTS

A vibration-type drive device according to each exemplary embodiment of the present disclosure includes the following elements. The vibration-type drive device includes a vibration-type actuator having a vibrating body, the vibrating body including an elastic body and an electro-mechanical energy conversion element, and a contact body, which is in contact with the elastic body, and a control device for the vibration-type actuator.

The vibration-type drive device is a vibration-type drive device in which the vibrating body and the contact body are moved relative to each other in predetermined movement directions by vibration of the vibrating body. Then, the above-mentioned vibration is generated in the vibrating body by a voltage applied to the electro-mechanical energy conversion element.

Then, the vibration-type drive device includes a neural network which receives, as inputs, a vibrational state of the vibrating body and command values for a thrust and a relative speed occurring between the vibrating body and the contact body. Then, to control a thrust and a relative speed occurring between the vibrating body and the contact body, the neural network outputs a setting value for an operational parameter of the above-mentioned applied voltage.

Various exemplary embodiments, features, and aspects of the present disclosure will be described in detail below with reference to the drawings.

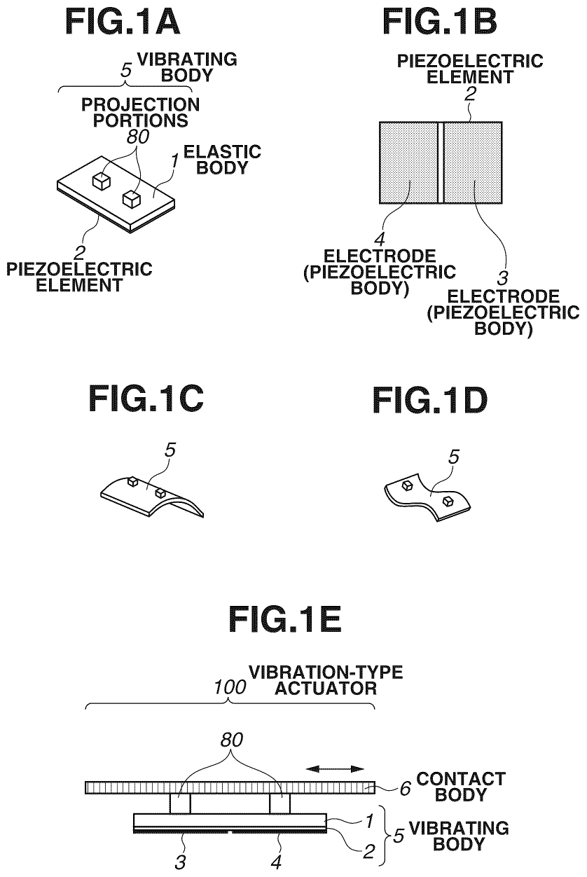

FIGS. 1A, 1B, 1C, 1D, and 1E are diagrams illustrating examples of a configuration and a vibration shape of a vibration-type actuator 100 according to a first exemplary embodiment. The configuration and operation principle of the vibration-type actuator 100 according to the first exemplary embodiment are described with reference to FIGS. 1A to 1E.

The vibration-type actuator 100 according to the first exemplary embodiment is configured to include, as illustrated in FIG. 1E, a vibrating body 5 and a contact body 6. The vibrating body 5 is configured with, as illustrated in FIGS. 1A and 1E, a piezoelectric element 2 and an elastic body 1, which includes two projection portions 80, which are in contact with the contact body 6. The piezoelectric element 2 is a component portion for causing the vibrating body 5 to vibrate.

Moreover, the piezoelectric element 2 is configured with a piezoelectric material and electrodes 3 and 4, in which, on the surface of the piezoelectric material subjected to polarization treatment, as illustrated in FIG. 1B, the electrode 3 and the electrode 4, which are configured to allow respective voltages to be independently applied thereto, are formed. Furthermore, piezoelectric ceramic can be used as the piezoelectric material. The piezoelectric element 2 is an example of an electro-mechanical energy conversion element, and, in response to alternating-current voltages being applied to the electrodes 3 and 4, vibrations are excited in the piezoelectric element 2.

The two electrodes 3 and 4 are made to be electrodes the space between which is electrically insulated, and two alternating-current voltages the phase of each of which is able to independently change are applied to the two electrodes 3 and 4. Moreover, the whole surface of the reverse side of the piezoelectric element 2 is made to be an electrode, and is configured to allow the ground potential to be connected thereto from the obverse side of the piezoelectric element 2 through a via (via hole) (not illustrated) provided in a part of the piezoelectric element 2. While the piezoelectric material is one piece of piezoelectric material, for explanation of an electrical circuit, the electrode 3, the electrode for the ground potential, and a region of the piezoelectric material sandwiched between them may be collectively referred to as a “piezoelectric body 3”. This designation also applies to a “piezoelectric body 4”.

The contact body 6 illustrated in FIG. 1E is a slider which is in pressed contact with the projection portions 80 of the vibrating body 5 at a fixed pressure force by a pressure mechanism (not illustrated). The contact body (slider) 6 is configured to move relatively in directions indicated by a double-headed arrow in FIG. 1E by vibrations excited by the vibrating body 5.

FIGS. 1C and 1D are diagrams illustrating examples of vibration modes of the vibrating body 5. FIG. 1C illustrates the vibration shape of a vibration mode which is excited by the vibrating body 5 when alternating-current voltages which are identical in amplitude and phase are applied to the piezoelectric body 3 and the piezoelectric body 4 (an upthrust vibration mode). The upthrust vibration mode is one of natural vibration modes of the vibrating body 5, and the direction of the natural vibration is a direction approximately perpendicular to a contact surface of the vibrating body 5 with the contact body 6. The degree of identicalness of amplitude and phase can be determined by the user according to the desired quality of vibrational wave.

On the other hand, FIG. 1D illustrates the vibration shape of a vibration mode which is excited by the vibrating body 5 when alternating-current voltages which are identical in amplitude and opposite in phase are applied to the piezoelectric body 3 and the piezoelectric body 4 (an advancing vibration mode). The advancing vibration mode is one of natural vibration modes of the vibrating body 5, and the direction of the natural vibration is a direction approximately parallel to a contact surface of the vibrating body 5 with the contact body 6 and approximately coincides with the above-mentioned direction of movement.

As an example, when the phase difference between alternating-current voltages which are applied to the piezoelectric body 3 and the piezoelectric body 4 is set to 0°, a vibration in the vibration mode illustrated in FIG. 1C (upthrust vibration mode) is excited.

Moreover, when the phase difference between alternating-current voltages which are applied to the piezoelectric body 3 and the piezoelectric body 4 is set to 180°, a vibration in the vibration mode illustrated in FIG. 1D (advancing vibration mode) is excited.

Additionally, when the phase difference between alternating-current voltages which are applied to the piezoelectric body 3 and the piezoelectric body 4 is set to a phase difference other than 0° and 180° (in actuality, about a range of +120° from 0° being used), both the vibration modes illustrated in FIGS. 1C and 1D are simultaneously excited. In this case, the contact body (slider) 6, which is in pressed contact with the projection portions 80 provided in the vibrating body 5, moves in the longitudinal direction of a rectangle of the vibrating body 5. Then, as the phase difference is more away from 0°, the amplitude in the vibration mode illustrated in FIG. 1D (advancing vibration mode) becomes larger, so that the relative speed between the contact body (slider) 6 and the vibrating body 5 increases.

Moreover, forces which the vibrating body 5 receives include a piezoelectric vibration force which is generated by applying alternating-current voltages to the piezoelectric body 3 and the piezoelectric body 4 and which causes a vibration to be generated in the vibrating body 5, a reaction force which the vibrating body 5 receives from a supporting member (not illustrated), and a reaction force which is received from the contact body (slider) 6. Among these, a vibration corresponding to a force (piezoelectric vibration force) which is generated by applying alternating-current voltages to the piezoelectric body 3 and the piezoelectric body 4 constituting the vibrating body 5 is referred to as a “first vibrational component”, and a vibration occurring in the vibrating body 5 by a reaction force which is received from the contact body (slider) 6 is referred to as a “second vibrational component”.

Moreover, the term “contact body 6” refers to a member which is in contact with the vibrating body 5 and moves relative with respect to the vibrating body 5 by a vibration generated in the vibrating body 5. The contact between the contact body 6 and the vibrating body 5 is not limited to direct contact, in which no other member intervenes between the contact body 6 and the vibrating body 5. As long as the contact body 6 relatively moves with respect to the vibrating body 5 by a vibration generated in the vibrating body 5, the contact between the contact body 6 and the vibrating body 5 can be indirect contact, in which another member intervenes between the contact body 6 and the vibrating body 5.

The “other member” is not limited to a member (for example, a high friction material made from a sintered body) independent from the contact body 6 and the vibrating body 5. The “other member” can be a surface-treated portion formed by, for example, plating or nitriding treatment in the contact body 6 or the vibrating body 5.

Moreover, the term “vibrating body 5” refers to a member which includes an elastic body 1 and a piezoelectric element (an electro-mechanical energy conversion element) 2 and which vibrates with an alternating-current voltage being applied to the piezoelectric element 2. The elastic body 1 is made mainly from metal or ceramic, and the piezoelectric element 2 can also be used as the elastic body 1.

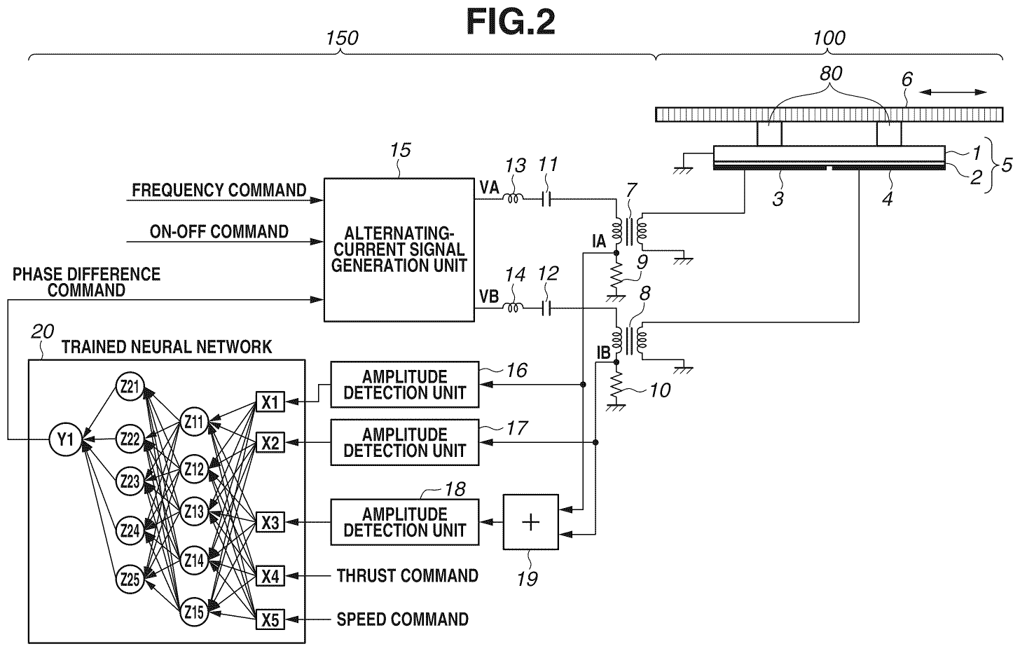

FIG. 2 is a diagram illustrating a first configuration example of a drive device 150 for a vibration-type actuator 100 according to the first exemplary embodiment.

The vibration-type actuator 100 includes a vibrating body 5, which includes an elastic body 1 and a piezoelectric element 2, and a contact body 6, which is in contact with the elastic body 1. The piezoelectric element 2 is an example of an electro-mechanical energy conversion element. The contact body 6 relatively moves with respect to the vibrating body 5 by a vibration of the vibrating body 5 which is excited by applying alternating-current voltages to the piezoelectric element 2.

The drive device 150 is an example of a control device for the vibration-type actuator 100. The drive device 150 includes transformers 7 and 8, resistors 9 and 10, capacitors 11 and 12, inductors 13 and 14, an alternating-current signal generation unit 15, amplitude detection units 16 to 18, an addition unit 19, and a neural network 20.

The configuration illustrated in FIG. 2 includes the vibration-type actuator 100, a generation unit for alternating-current voltages to be applied to the vibration-type actuator 100, an estimation unit for the thrust and speed of the vibration-type actuator 100, and a portion concerning speed and thrust control over the vibration-type actuator 100.

First, the generation unit for alternating-current voltages is described. The alternating-current signal generation unit 15 generates two-phase alternating-current signal (first signal) VA and alternating-current signal (second signal) VB based on a frequency command and an ON-OFF command which are output from a command unit (not illustrated) and a phase difference command which is output from the neural network 20 described below. Then, the alternating-current signal VA and the alternating-current signal VB are connected to the primary side winding wires of the transformer 7 and the transformer 8 via series resonance circuits composed of the inductors 13 and 14 and the capacitors 11 and 12, respectively.

The primary side winding wire of the transformer 7 receives, as an input, the alternating-current signal VA via the series resonance circuit. The primary side winding wire of the transformer 8 receives, as an input, the alternating-current signal VB via the series resonance circuit.

Here, while, in the first exemplary embodiment, an example in which, to perform waveform shaping or prevent or reduce a variation in voltage amplitude to the piezoelectric body 3 and the piezoelectric body 4, the alternating-current signal generation unit 15 is connected to the transformer 7 and the transformer 8 via series resonance circuits has been described, the first exemplary embodiment is not limited to this example. The alternating-current signal generation unit 15 can be connected to only one of the inductor and the capacitor, or series resonance circuits do not need to be connected to the alternating-current signal generation unit 15.

The voltages input to the primary side winding wires of the transformer 7 and the transformer 8 are boosted, and are then applied, as a first drive voltage and a second drive voltage, to the piezoelectric body 3 and the piezoelectric body 4 constituting the vibrating body 5 of the vibration-type actuator 100 connected to the secondary side winding wires of the transformer 7 and the transformer 8.

The secondary side winding wire of the transformer 7 is connected to the piezoelectric body 3. The secondary side winding wire of the transformer 8 is connected to the piezoelectric body 4.

The transformer 7 generates an alternating-current voltage which is to be applied to the piezoelectric body 3. The transformer 8 generates an alternating-current voltage which is to be applied to the piezoelectric body 4.

The inductor values of the secondary side winding wires of the transformer 7 and the transformer 8 are frequency-matched with the braking capacities of the piezoelectric body 3 and the piezoelectric body 4. This causes currents approximately proportional to the vibration speeds of distortions occurring in the piezoelectric body 3 and the piezoelectric body 4 to flow through the primary side winding wires of the transformer 7 and the transformer 8.

The resistor 9 and the resistor 10 used for current detection are connected in series to the primary side winding wires of the transformer 7 and the transformer 8, and are used to detect currents flowing through the primary side winding wires of the transformer 7 and the transformer 8, thus generating a current signal IA and a current signal IB. A relationship between the current signal IA and the current signal IB and the vibration of the vibrating body 5 is separately described below.

The current signal IA is a signal representing a current flowing through the primary side winding wire of the transformer 7. The current signal IB is a signal representing a current flowing through the primary side winding wire of the transformer 8.

Next, a configuration related to generation of a phase difference command is described. The generation of a phase difference command is performed by the trained neural network (NN) 20. The term “neural network” is hereinafter abbreviated to “NN” for descriptive purposes. The NN 20 is configured with five input layers X1 to X5, intermediate layers Z11 to Z25 as two layers×5, and one output layer Y1, and is configured in such a manner that the output layer Y1 outputs a phase difference command.

The intermediate layers Z11 to Z25 perform arithmetic operations according to signals supplied from the input layers X1 to X5. The output layer Y1 outputs a phase difference command according to signals supplied from the intermediate layers Z11 to Z25. The phase difference command is an example of a command that manipulates variables of alternating-current voltages to be applied to the electrodes 3 and 4. The phase difference command is a command for a phase difference between the alternating-current signal VA and the alternating-current signal VB. The alternating-current signal VA is a signal to be supplied to the primary side winding wire of the transformer 7. The alternating-current signal VB is a signal to be supplied to the primary side winding wire of the transformer 8.

Five signals are input to input layers X1 to X5 of the NN 20. Signals which the amplitude detection units 16 to 18 output are input to input layers X1 to X3, and, a thrust command and a speed command output from the command unit (not illustrated) are input to the input layers X4 and X5, respectively.

The amplitude detection unit 16 detects the amplitude of the current signal IA and outputs the detected amplitude to the input layer X1. The amplitude detection unit 17 detects the amplitude of the current signal IB and outputs the detected amplitude to the input layer X2. The addition unit 19 outputs a signal obtained by adding the current signal IA and the current signal IB together. The amplitude detection unit 18 detects the amplitude of an output signal from the addition unit 19 and outputs the detected amplitude to the input layer X3.

The input layer X1 receives, as an input, a detected value of the amplitude of the current signal IA, which is based on a current flowing through the primary side winding wire of the transformer 7, from the amplitude detection unit 16.

The input layer X2 receives, as an input, a detected value of the amplitude of the current signal IB, which is based on a current flowing through the primary side winding wire of the transformer 8, from the amplitude detection unit 17.

The input layer X3 receives, as an input, a detected value of the amplitude of a signal obtained by adding together the current signal IA, which is based on a current flowing through the primary side winding wire of the transformer 7, and the current signal IB, which is based on a current flowing through the primary side winding wire of the transformer 8, from the amplitude detection unit 18. The input layers X1 to X3 receive, as inputs, signals related to the alternating-current signals VA and VB.

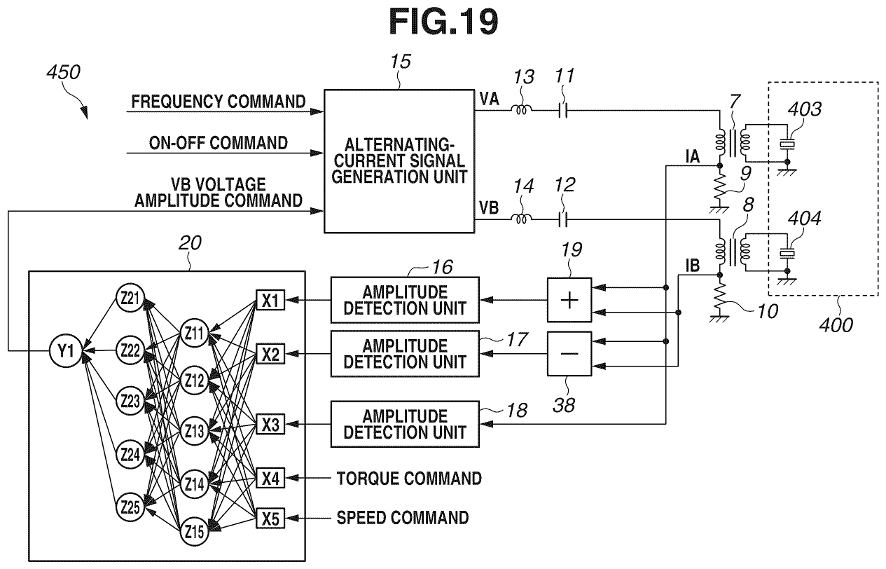

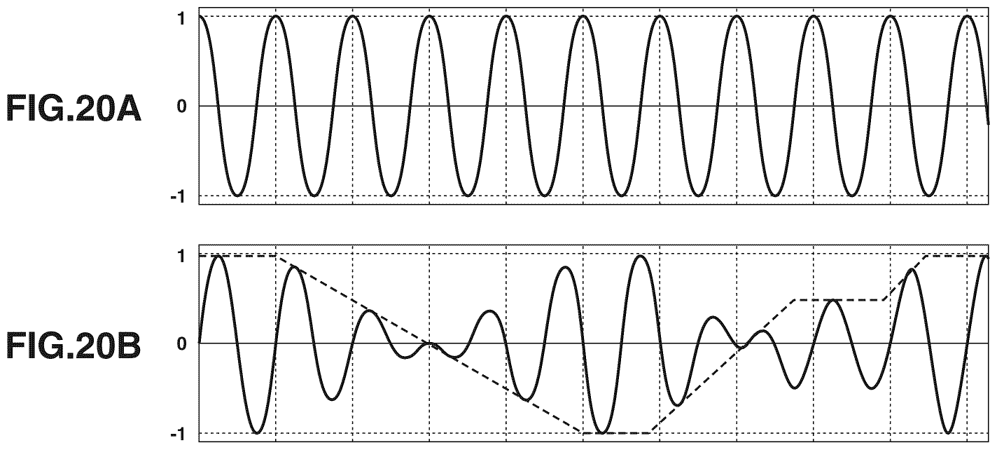

The input layer X4 receives, as an input, a thrust command from the command unit. The thrust command is a command value for a thrust occurring between the vibrating body 5 and the contact body 6. Here, the term “thrust” includes both “torque” and “force”. An example of the torque is described below with reference to FIG. 19. The “torque” is a moment of “force× distance”, the unit of which is newton-meter (N·m), the unit of “force” is newton (N), and using either of the “torque” and “force” enables implementing the same control. Either of torque and force can be used for an action for propelling some sort of object.

The input layer X5 receives, as an input, a speed command from the command unit. The speed command is a command value for a relative speed of the contact body 6 with respect to the vibrating body 5.

The signal which the addition unit 19 outputs is a signal corresponding to the vibrational state illustrated in FIG. 1C, and the amplitude thereof is equivalent to an amplitude in the upthrust vibration mode of the vibrating body 5.

Moreover, each of the amplitude detection units 16 to 18 extracts, from the input signal, a basic wave component of the input signal by a band-pass filter or low-pass filter and thus detects the amplitude thereof. Moreover, each of the amplitude detection units 16 to 18 can convert the value of the detected amplitude with use of predetermined functional operations or a look-up table and then input the converted amplitude to the NN 20.

Moreover, the vibrating body 5 receives a reaction force which is generated according to a relative speed with respect to the contact body (slider) 6 and a generated relative force, and a second vibrational component caused by the received reaction force is superposed on the vibrating body 5, so that the amplitudes of the current signal IA and the current signal IB change. The NN 20 generates a phase difference command according to such a change of the amplitudes of the current signal IA and the current signal IB and the speed and thrust commands, thus controlling a relative speed and relative force between the contact body 6 and the vibrating body 5.

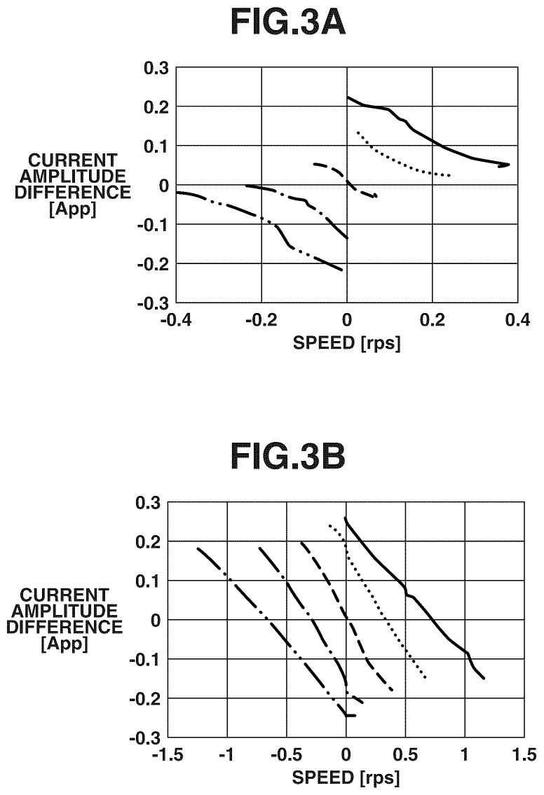

FIGS. 3A and 3B are diagrams each illustrating a relationship between “the amplitude of the current signal IA−the amplitude of the current signal IB” and the speed. The speed represents a relative speed between the contact body 6 and the vibrating body 5.

FIG. 3A illustrates an example in a case where the amplitude of “the current signal IA+the current signal IB” is relatively small, and FIG. 3B illustrates an example in a case where the amplitude of “the current signal IA+the current signal IB” is relatively large.

The line types illustrated in each of FIGS. 3A and 3B indicate differences of the phase difference between the alternating-current signal VA and the alternating-current signal VB, and represent solid line) (90°, dotted line) (45°, dashed line) (0°, dashed-dotted line) (−45°, and dashed-two dotted line) (−90°.

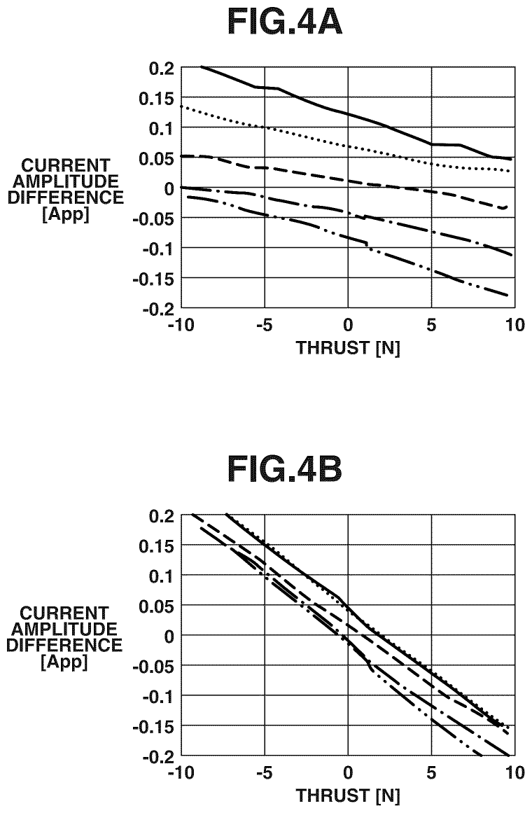

FIGS. 4A and 4B are diagrams each illustrating a relationship between “the amplitude of the current signal IA−the amplitude of the current signal IB” and the thrust. The thrust represents a thrust occurring between the vibrating body 5 and the contact body 6.

FIG. 4A illustrates an example in a case where the amplitude of “the current signal IA+the current signal IB” is relatively small, and FIG. 4B illustrates an example in a case where the amplitude of “the current signal IA+the current signal IB” is relatively large.

The line types illustrated in each of FIGS. 4A and 4B indicate differences of the phase difference between the alternating-current signal VA and the alternating-current signal VB, and represent solid line) (90°, dotted line) (45°, dashed line) (0°, dashed-dotted line) (−45°, and dashed-two dotted line) (−90°.

In this way, it is understood that the respective amplitudes of the current signal IA, the current signal IB, and “the current signal IA+the current signal IB”, a phase difference between the alternating-current signal VA and the alternating-current signal VB, the speed, and the thrust have a strong correlation with each other.

Therefore, in the situation where the phase difference between the alternating-current signal VA and the alternating-current signal VB and an external force which is applied in the movement directions of the contact body 6 are preliminarily set under various conditions, the respective amplitudes of the current signal IA, the current signal IB, and “the current signal IA+the current signal IB” and the relative speed between the contact body 6 and the vibrating body 5 are preliminarily measured. Then, the NN 20 is trained based on the measured pieces of data, so that the NN 20 is performing learning in such a way as to output a phase difference between the alternating-current signal VA and the alternating-current signal VB. In this way, the NN 20 becomes able to control speed and thrust.

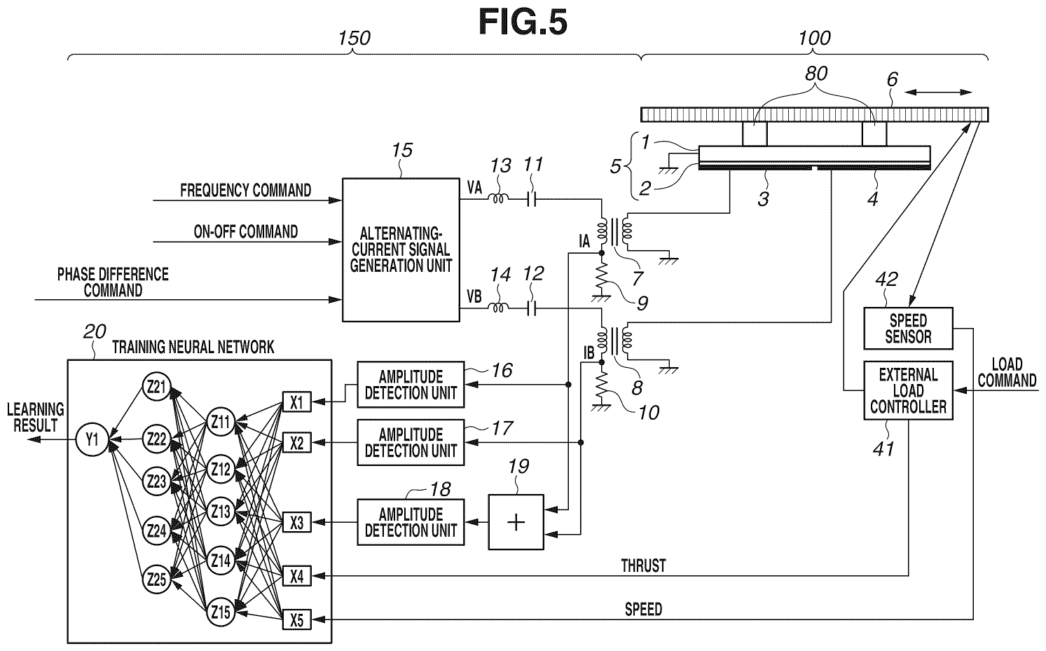

FIG. 5 is a diagram illustrating a configuration example of a device which is used for the NN 20 to perform learning. Elements similar to those illustrated in FIG. 2 are assigned the respective same reference characters as those in FIG. 2, and the detailed description thereof is omitted here.

An external load controller 41, which applies an external force acting on driving in the movement directions of the contact body 6, is controlling the external force according to a load command output from the command unit (not illustrated). A speed sensor 42 detects a relative speed between the contact body 6 and the vibrating body 5.

In the training NN 20, as with FIG. 2, output signals from the amplitude detection units 16 to 18 are input to the input layers X1 to X3, respectively, and, instead of the thrust command and the speed command, the thrust measured by the external load controller 41 and the speed detected by the speed sensor 42 are input to the input layers X4 and X5, respectively.

Next, operations of the NN 20 at the time of performing learning are described with reference to FIG. 5. The command unit (not illustrated) gives a phase difference command, a load command, and a frequency command under various conditions, and thus causes the NN 20 to perform learning in such a manner that the output value of the output layer Y1 obtained at that time coincides with the frequency difference command.

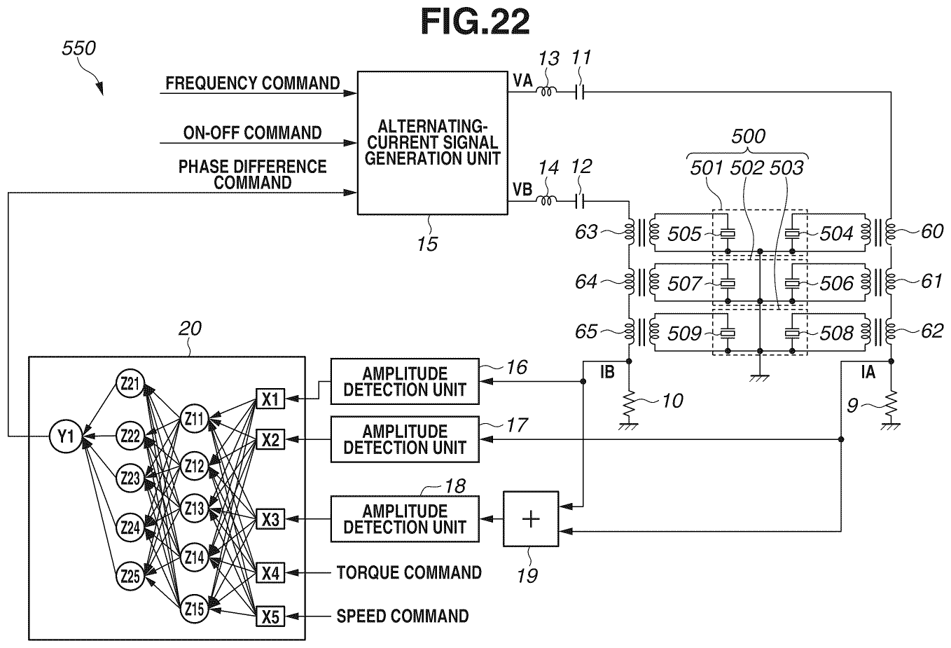

The input layer X4 receives, as an input, a thrust occurring between the vibrating body 5 and the contact body 6 from the external load controller 41. The input layer X5 receives, as an input, a relative speed of the contact body 6 with respect to the vibrating body 5 from the speed sensor 42. The NN 20 illustrated in FIG. 2 is a trained neural network which has been trained with inputs to the input layers X1 to X5. Furthermore, in the case of a configuration illustrated in FIG. 22 described below, when the NN 20 performs learning, the NN 20 is trained with the input layer X4 receiving, as an input, a torque which occurs between the vibrating body and the contact body.

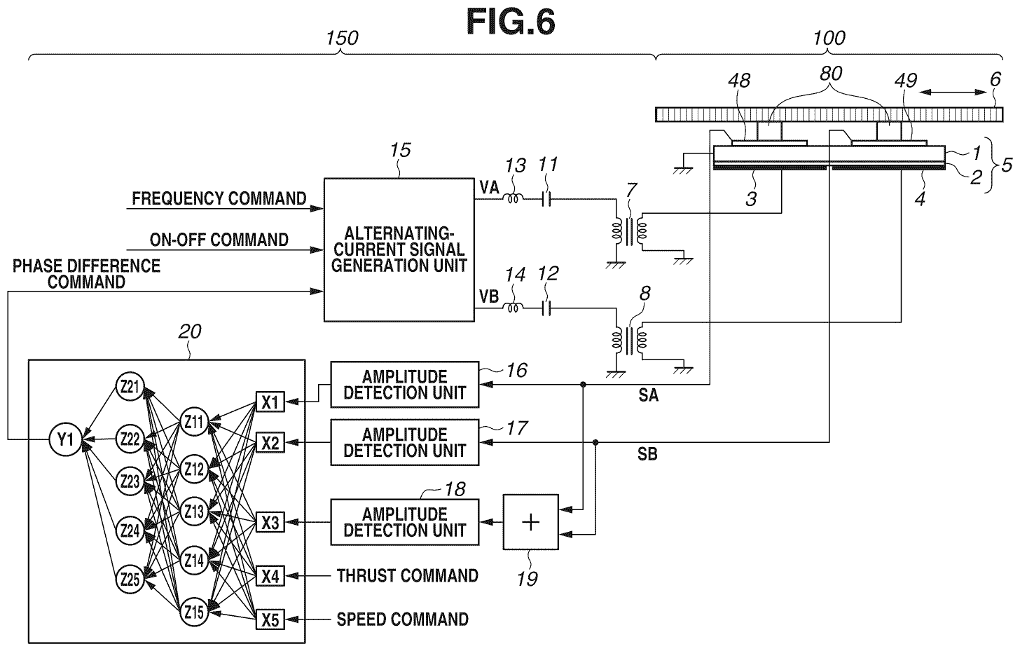

FIG. 6 is a diagram illustrating a second configuration example of the drive device 150 for the vibration-type actuator 100 according to the first exemplary embodiment. FIG. 6 is a diagram illustrating an example of the case where the vibrating body 5 is provided with a piezoelectric element for detecting the vibration of the vibrating body 5 separately from the driving piezoelectric element. Constituent elements similar to the constituent elements illustrated in FIG. 2 are assigned the respective same reference characters as those in FIG. 2, and the detailed description thereof is omitted here.

A piezoelectric body 48 and a piezoelectric body 49 constitute the piezoelectric element for detecting the vibration, and are bonded to a surface of the vibrating body 5 opposite to the surface thereof to which the piezoelectric body 3 and the piezoelectric body 4 are bonded. Therefore, the piezoelectric body 48 and the piezoelectric body 49 are able to accurately detect vibrations close to the vibrations of the piezoelectric body 3 and the piezoelectric body 4 for driving. Then, the piezoelectric body 48 outputs a vibration detection signal SA for the vibrating body 5, and the piezoelectric body 49 outputs a vibration detection signal SB for the vibrating body 5.

The piezoelectric body 48 is bonded to a surface region of the vibrating body 5 opposite to the surface region thereof to which the piezoelectric body 3 is bonded. The piezoelectric body 49 is bonded to a surface region of the vibrating body 5 opposite to the surface region thereof to which the piezoelectric body 4 is bonded.

The amplitude detection unit 16 detects the amplitude of the vibration detection signal SA, and outputs the detected amplitude of the vibration detection signal SA to the input layer X1. The amplitude detection unit 17 detects the amplitude of the vibration detection signal SB, and outputs the detected amplitude of the vibration detection signal SB to the input layer X2. The addition unit 19 outputs a signal obtained by adding the vibration detection signal SA and the vibration detection signal SB together. The amplitude detection unit 18 detects the amplitude of the signal output from the addition unit 19, and outputs the detected amplitude of the signal output from the addition unit 19 to the input layer X3.

The input layer X1 receives, as an input, the detected value of the amplitude of the vibration detection signal SA corresponding to the electrode 3 of the piezoelectric element 2 from the amplitude detection unit 16.

The input layer X2 receives, as an input, the detected value of the amplitude of the vibration detection signal SB corresponding to the electrode 4 of the piezoelectric element 2 from the amplitude detection unit 17.

The input layer X3 receives, as an input, the detected value of the amplitude of a signal obtained by adding the vibration detection signal SA corresponding to the electrode 3 of the piezoelectric element 2 and the vibration detection signal SB corresponding to the electrode 4 of the piezoelectric element 2 together from the amplitude detection unit 18.

The input layer X4 receives, as an input, a thrust command from the command unit. The thrust command is a command value for a thrust occurring between the vibrating body 5 and the contact body 6.

The input layer X5 receives, as an input, a speed command from the command unit. The speed command is a command value for a relative speed of the contact body 6 with respect to the vibrating body 5.

While, in FIGS. 3A and 3B and FIGS. 4A and 4B, the respective relationships between the difference in amplitude between the current signal IA and the current signal IB and the speed and the thrust are illustrated, the difference in amplitude between the vibration detection signal SA and the vibration detection signal SB also shows a similar tendency. Therefore, even in the configuration illustrated in FIG. 6, it is possible to perform control of thrust and speed with the NN 20 preliminarily before performing learning.

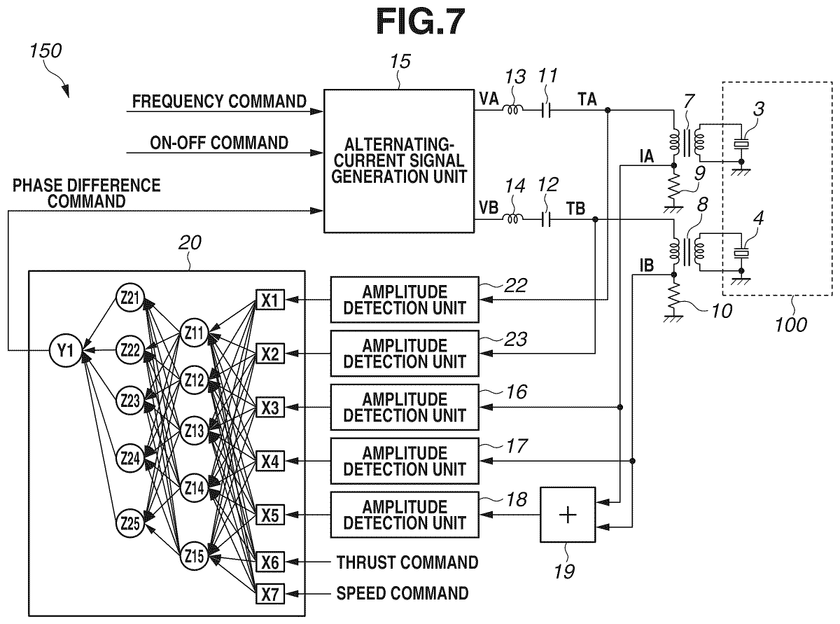

FIG. 7 is a diagram illustrating a third configuration example of the drive device 150 for the vibration-type actuator 100 according to the first exemplary embodiment. The configuration illustrated in FIG. 7 differs from the configuration illustrated in FIG. 2 in that the number of input layers of the NN 20 is increased from 5 to 7.

The drive device 150 illustrated in FIG. 7 additionally includes amplitude detection units 22 and 23 with respect to the drive device 150 illustrated in FIG. 2.

The NN 20 includes seven input layers X1 to X7, intermediate layers Z11 to Z25 as two layers×5, and one output layer Y1. The output layer Y1 outputs a phase difference command to the alternating-current signal generation unit 15.

A primary side voltage TA is a voltage which is to be applied to the primary side winding wire of the transformer 7. A primary side voltage TB is a voltage which is to be applied to the primary side winding wire of the transformer 8.

The amplitude detection unit 22 detects the amplitude of the primary side voltage TA, and outputs the detected amplitude to the input layer X1. The amplitude detection unit 23 detects the amplitude of the primary side voltage TB, and outputs the detected amplitude to the input layer X2.

The amplitude detection unit 16 detects the amplitude of the current signal IA, and outputs the detected amplitude to the input layer X3. The amplitude detection unit 17 detects the amplitude of the current signal IB, and outputs the detected amplitude to the input layer X4. The addition unit 19 outputs a signal obtained by adding the current signal IA and the current signal IB together. The amplitude detection unit 18 detects the amplitude of a signal output from the addition unit 19, and outputs the detected amplitude to the input layer X5.

The input layer X1 receives, as an input, the detected value of the amplitude of the primary side voltage TA, which is to be applied to the primary side winding wire of the transformer 7, from the amplitude detection unit 22.

The input layer X2 receives, as an input, the detected value of the amplitude of the primary side voltage TB, which is to be applied to the primary side winding wire of the transformer 8, from the amplitude detection unit 23.

The input layer X3 receives, as an input, the detected value of the amplitude of the current signal IA, which is based on a current flowing through the primary side winding wire of the transformer 7, from the amplitude detection unit 16.

The input layer X4 receives, as an input, the detected value of the amplitude of the current signal IB, which is based on a current flowing through the primary side winding wire of the transformer 8, from the amplitude detection unit 17.

The input layer X5 receives, as an input, the detected value of the amplitude of a signal obtained by adding the current signal IA, which is based on a current flowing through the primary side winding wire of the transformer 7, and the current signal IB, which is based on a current flowing through the primary side winding wire of the transformer 8, together from the amplitude detection unit 18.

The input layer X6 receives, as an input, a thrust command output from the command unit (not illustrated). The input layer X7 receives, as an input, a speed command output from the command unit (not illustrated).

Since the respective amplitudes of the primary side voltages TA and TB of the transformers 7 and 8 change together with the state of being input to other input layers according to the admittance characteristics of the piezoelectric body 3 and the piezoelectric body 4, which change depending on the vibrational state and temperature of the vibrating body 5, there is the possibility of improving the accuracy of thrust and speed.

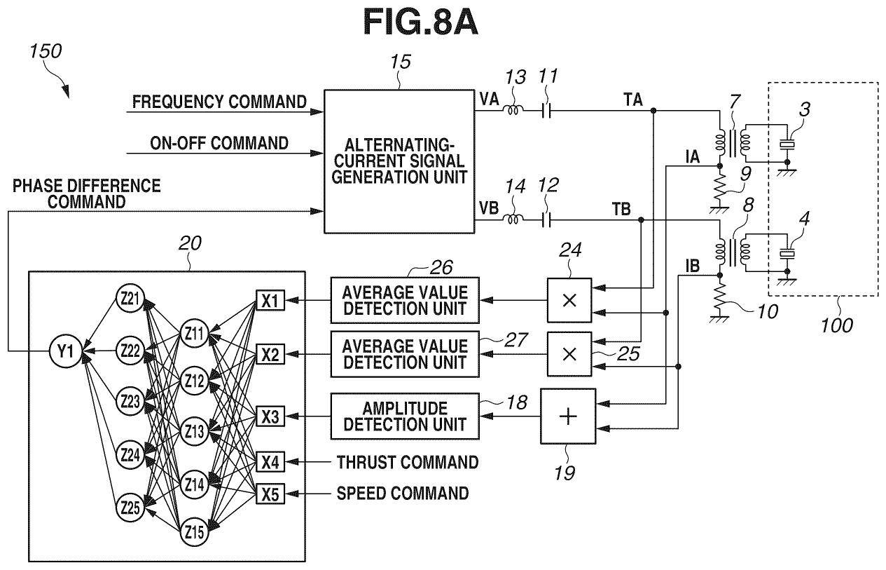

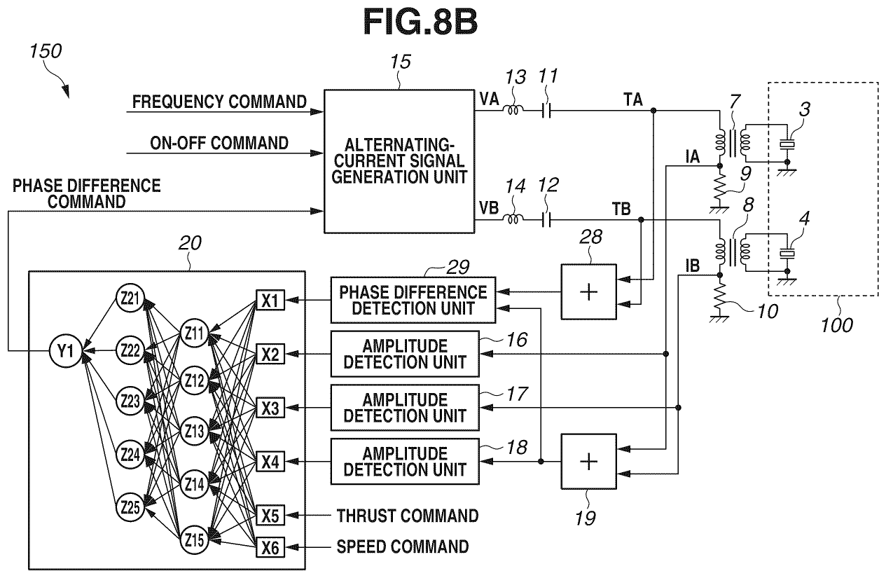

FIG. 8A is a diagram illustrating a fourth configuration example of the drive device 150 for the vibration-type actuator 100 according to the first exemplary embodiment. The above-described configuration illustrated in FIG. 2 uses the amplitude detection units 16 and 17 to detect the amplitudes of the current signal IA and the current signal IB and input the respective detected amplitudes to the input layers X1 and X2 of the NN 20. On the other hand, the configuration illustrated in FIG. 8A calculates electric powers by multiplying the primary side voltages TA and TB of the transformers 7 and 8 by the current signals IA and IB, respectively, and inputs the calculated electric power values to the input layers X1 and X2 of the NN 20, respectively.

The drive device 150 illustrated in FIG. 8A is a device obtained by removing the amplitude detection units 16 and 17 and adding multiplication units 24 and 25 and average value detection units 26 and 27 with respect to the drive device 150 illustrated in FIG. 2. The NN 20 includes five input layers X1 to X5, intermediate layers Z11 to Z25 as two layers×5, and one output layer Y1. The output layer Y1 outputs a phase difference command to the alternating-current signal generation unit 15.

A primary side voltage TA is a voltage which is to be applied to the primary side winding wire of the transformer 7. A primary side voltage TB is a voltage which is to be applied to the primary side winding wire of the transformer 8.

The multiplication unit 24 multiplies the primary side voltage TA of the transformer 7 by the current signal IA and then outputs an electric power. The average value detection unit 26 detects an average value of the electric power output from the multiplication unit 24, and inputs the detected average value to the input layer X1.

The multiplication unit 25 multiplies the primary side voltage TB of the transformer 8 by the current signal IB and then outputs an electric power. The average value detection unit 27 detects an average value of the electric power output from the multiplication unit 25, and inputs the detected average value to the input layer X2.

The addition unit 19 outputs a signal obtained by adding the current signal IA and the current signal IB together. The amplitude detection unit 18 detects the amplitude of a signal output from the addition unit 19, and outputs the detected amplitude to the input layer X3.

The input layer X1 receives, as an input, the detected value of an electric power of the primary side winding wire of the transformer 7 from the average value detection unit 26. Specifically, the input layer X1 receives, as an input, the detected value of an average value of a signal obtained by multiplying the primary side voltage TA, which is to be applied to the primary side winding wire of the transformer 7, by the current signal IA, which is based on a current flowing through the primary side winding wire of the transformer 7, from the average value detection unit 26.

The input layer X2 receives, as an input, the detected value of an electric power of the primary side winding wire of the transformer 8 from the average value detection unit 27. Specifically, the input layer X2 receives, as an input, the detected value of an average value of a signal obtained by multiplying the primary side voltage TB, which is to be applied to the primary side winding wire of the transformer 8, by the current signal IB, which is based on a current flowing through the primary side winding wire of the transformer 8, from the average value detection unit 27.

The input layer X3 receives, as an input, the detected value of the amplitude of a signal obtained by adding the current signal IA, which is based on a current flowing through the primary side winding wire of the transformer 7, and the current signal IB, which is based on a current flowing through the primary side winding wire of the transformer 8, together from the amplitude detection unit 18.

The input layer X4 receives, as an input, a thrust command output from the command unit (not illustrated). The input layer X5 receives, as an input, a speed command output from the command unit (not illustrated).

The multiplication units 24 and 25 multiply the primary side voltages TA and TB of the transformers 7 and 8 by the current signals IA and IB, respectively. The average value detection units 26 and 27 calculate respective electric powers by detecting the respective average values of outputs of the multiplication units 24 and 25, respectively.

The difference between an electric power generated on the alternating-current signal VA side and an electric power generated on the alternating-current signal VB side has a correlation with a difference between the respective amplitudes of the current signal IA and the current signal IB, and also has a correlation with thrust and speed in a similar way. Accordingly, the NN 20 preliminarily learns a relationship with differences in electric power, thus becoming able to control thrust and speed.

FIG. 8B is a diagram illustrating a fifth configuration example of the drive device 150 for the vibration-type actuator 100 according to the first exemplary embodiment. The configuration illustrated in FIG. 8B differs from that illustrated in FIG. 2 in that the number of input layers of the NN 20 is increased from 5 to 6.

The drive device 150 illustrated in FIG. 8B is a device obtained by adding an addition unit 28 and a phase difference detection unit 29 to the drive device 150 illustrated in FIG. 2.

The NN 20 includes six input layers X1 to X6, intermediate layers Z11 to Z25 as two layers×5, and one output layer Y1. The output layer Y1 outputs a phase difference command to the alternating-current signal generation unit 15.

The addition unit 19 outputs a current signal obtained by adding the current signal IA of the transformer 7 and the current signal IB of the transformer 7 together. The addition unit 28 outputs a voltage obtained by adding the primary side voltage TA of the transformer 7 and the primary side voltage TB of the transformer 8 together.

The phase difference detection unit 29 detects a phase difference between the current signal output from the addition unit 19 and the voltage output from the addition unit 28, and outputs the detected phase difference to the input layer X1.

The amplitude detection unit 16 detects the amplitude of the current signal IA, and outputs the detected amplitude to the input layer X2. The amplitude detection unit 17 detects the amplitude of the current signal IB, and outputs the detected amplitude to the input layer X3. The amplitude detection unit 18 detects the amplitude of a current signal output from the addition unit 19, and outputs the detected amplitude to the input layer X4.

The input layer X1 receives, as an input, the detected value of a phase difference between a voltage obtained by adding the primary side voltage TA, which is to be applied to the primary side winding wire of the transformer 7, and the primary side voltage TB, which is to be applied to the primary side winding wire of the transformer 8, together and a signal obtained by adding the current signal IA, which is based on a current flowing through the primary side winding wire of the transformer 7, and the current signal IB, which is based on a current flowing through the primary side winding wire of the transformer 8, together from the phase difference detection unit 29.

The input layer X2 receives, as an input, the detected value of the amplitude of the current signal IA, which is based on a current flowing through the primary side winding wire of the transformer 7, from the amplitude detection unit 16.

The input layer X3 receives, as an input, the detected value of the amplitude of the current signal IB, which is based on a current flowing through the primary side winding wire of the transformer 8, from the amplitude detection unit 17.

The input layer X4 receives, as an input, the detected value of the amplitude of a signal obtained by adding the current signal IA, which is based on a current flowing through the primary side winding wire of the transformer 7, and the current signal IB, which is based on a current flowing through the primary side winding wire of the transformer 8, together from the amplitude detection unit 18.

The input layer X5 receives, as an input, a thrust command output from the command unit (not illustrated). The input layer X6 receives, as an input, a speed command output from the command unit (not illustrated).

The phase difference which the phase difference detection unit 29 detects represents a state corresponding to a difference between a natural frequency and a vibrational frequency in the upthrust vibration mode illustrated in FIG. 1C, and the detected phase difference being input to the NN 20 can improve control characteristics for thrust and speed.

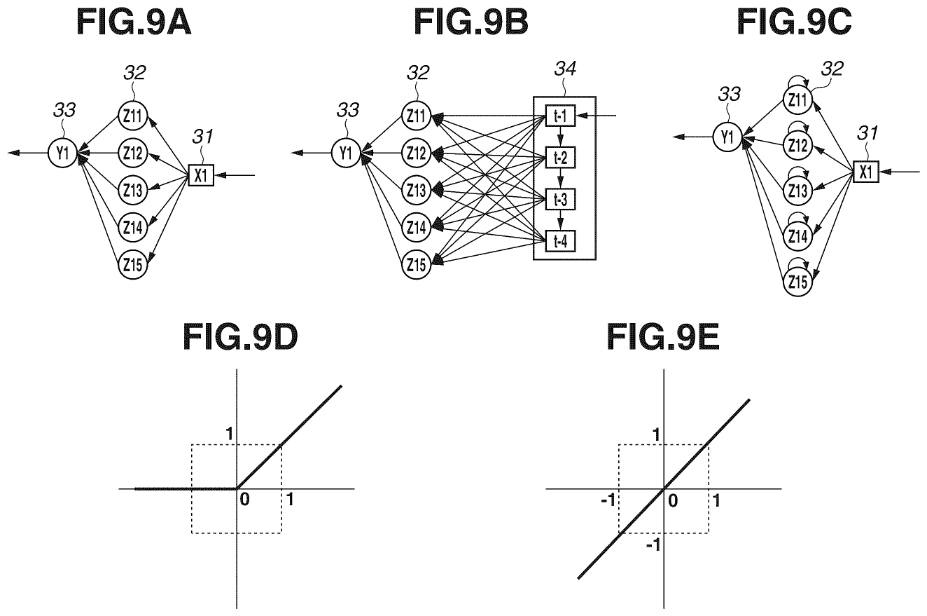

FIGS. 9A, 9B, 9C, 9D, and 9E are diagrams illustrating examples of a configuration of the neural network 20. FIG. 9A is a diagram illustrating a basic configuration of the neural network 20, which includes an input layer 31, intermediate layers 32, and an output layer 33. While FIG. 9A illustrates one input layer 31, five intermediate layers 32, and one output layer 33, the input layer 31 can include a plurality of input layers.

FIG. 9D illustrates an example of an activation function which is used in the intermediate layers 32, and the activation function is usually a function called a “rectified linear unit (ReLU)”. FIG. 9E illustrates an example of an activation function which is used in the output layer 33, which is usually called an “identity function” and directly outputs an input.

FIG. 9B illustrates a neural network 20 configured in such a manner that time-series signals are connected to an input layer 34. The input layer 34 receives, as an input, an input signal for each isochronal sample, at time step t-1, an input signal one sample time ago is retained, and at time step t-2, an input signal two sample times ago is retained, so that the input layer 34 sequentially inputs time-series signals to the intermediate layers 32. In this way, the input layer 34 inputs a time-series plurality of signals (values) to the neural network 20, so that it is possible to perform accurate control over speed and thrust with respect to a fluctuating input signal.

FIG. 9C illustrates a neural network 20 in which a route for returning the state of an intermediate layer 32 to the same intermediate layer 32 is provided. The configuration illustrated in FIG. 9C is a configuration having an advantageous effect of increasing the followability to a time-series command signal as with the configuration illustrated in FIG. 9B, and is called a “recurrent neural network”. The intermediate layer 32 is a recursive connection for returning an output to an input.

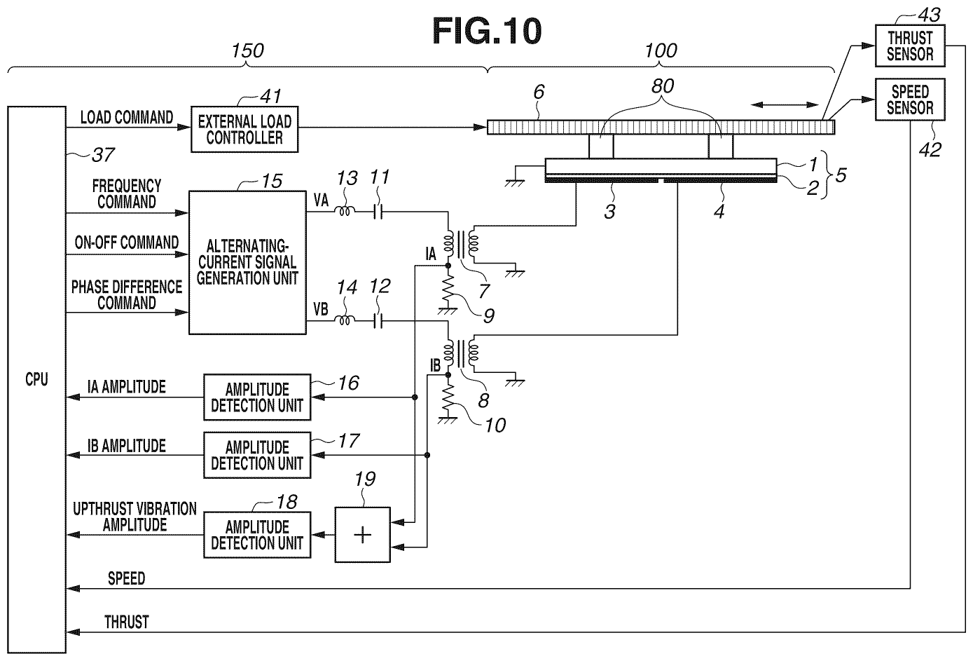

FIG. 10 illustrates a configuration example of a device which is used for the NN 20 to perform learning. A central processing unit (CPU) 37 is measuring and collecting the IA amplitude, the IB amplitude, and the upthrust vibration amplitude, which are vibrational states of the vibrating body 5, and the speed and thrust of the vibration-type actuator 100 obtained when the vibration-type actuator 100 has been driven on various drive conditions, thus performing generation of a learned model (trained model) of the NN 20. A thrust sensor 43 measures the thrust of the vibration-type actuator 100, and a speed sensor 42 measures the speed of the vibration-type actuator 100.

An amplitude detection unit 16 detects the amplitude of the current signal IA, and outputs the detected amplitude as an IA amplitude to the CPU 37. An amplitude detection unit 17 detects the amplitude of the current signal IB, and outputs the detected amplitude as an IB amplitude to the CPU 37. An amplitude detection unit 18 detects the amplitude of a signal obtained by adding the current signal IA and the current signal IB together, and outputs the detected amplitude as an upthrust vibration amplitude to the CPU 37.

The thrust sensor 43 detects the thrust of the vibration-type actuator 100, and outputs the detected thrust to the CPU 37. The speed sensor 42 detects the speed of the vibration-type actuator 100, and outputs the detected speed to the CPU 37.

The CPU 37 receives, as inputs, the IA amplitude, the IB amplitude, the upthrust vibration amplitude, and the thrust and speed of the vibration-type actuator 100, and thus performs generation of a learned model (trained model) of the NN 20. The CPU 37 outputs a load command to the external load controller 41. Moreover, the CPU 37 outputs a frequency command, an ON-OFF command, and a phase difference command to the alternating-current signal generation unit 15.

In addition to performing data collection for a learning operation of the NN 20 and causing the NN 20 to perform learning, the CPU 37 is performing control of the thrust and control of the upthrust vibration amplitude. First, the control of the thrust is described. The external load controller 41 controls loads, such as brakes and motors, connected to the vibration-type actuator 100 according to the load command received from the CPU 37. The CPU 37 outputs the load command according to a predetermined thrust command sequence in such a manner that the thrust output from the thrust sensor 43 follows up the thrust command sequence, thus putting a predetermined load on the vibration-type actuator 100.

Next, an operation of the CPU 37 for the control of the upthrust vibration amplitude is described. The CPU 37 controls the frequency command based on a predetermined upthrust vibration amplitude command sequence in such a manner that the upthrust vibration amplitude output from the amplitude detection unit 18 follows up the upthrust vibration amplitude command sequence.

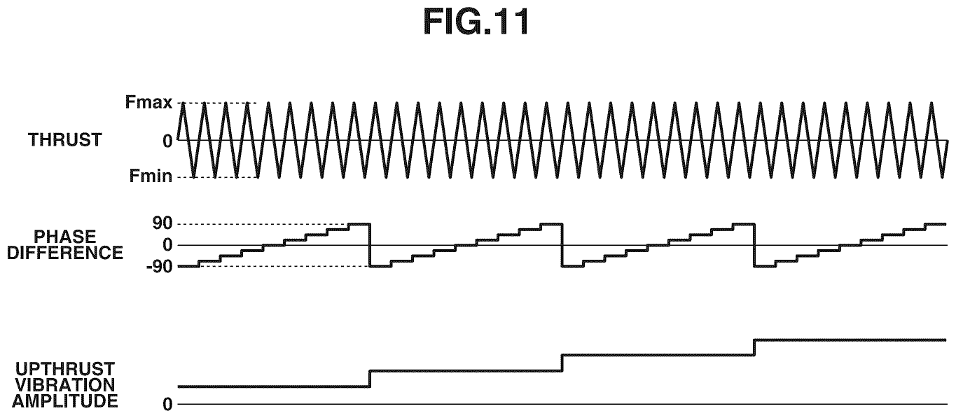

FIG. 11 illustrates a first example of a sequence for a thrust command, an upthrust vibration amplitude command, and a phase difference command, which are used for a learning operation of the NN 20. The CPU 37 is operating the thrust command in a triangular wave pattern, operating the load command in such a manner that the thrust reciprocates between a minimum value Fmin and a maximum value Fmax, switching the phase difference in a stepwise manner from −90° to 90°, and switching the upthrust vibration amplitude in a stepwise manner each time repeating setting of the phase difference. Then, the CPU 37 collects values of the IA amplitude, the IB amplitude, and the upthrust vibration amplitude, which are vibrational states during an operation of such a sequence being performed, and values of the speed and thrust of the vibration-type actuator 100, thus performing accumulation of learning data for the NN 20.

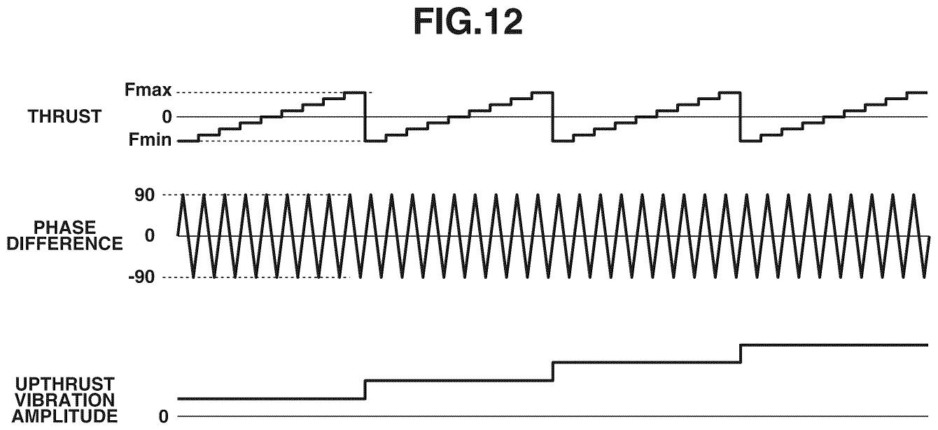

FIG. 12 illustrates a second example of a sequence for a thrust command, an upthrust vibration amplitude command, and a phase difference command, which are used for a learning operation of the NN 20. While, in the example illustrated in FIG. 11, the CPU 37 sweeps the thrust in a triangular wave pattern, in the example illustrated in FIG. 12, the CPU 37 sweeps the phase difference command in a triangular wave pattern. Since, even when momentarily exhibiting the same state according to the fluctuating speed of a phase difference or thrust, the vibrational state of the vibration-type actuator 100 has different responses, performing accumulation of learning data on various conditions in addition to the examples illustrated in FIG. 11 and FIG. 12 is important in building a good learning model.

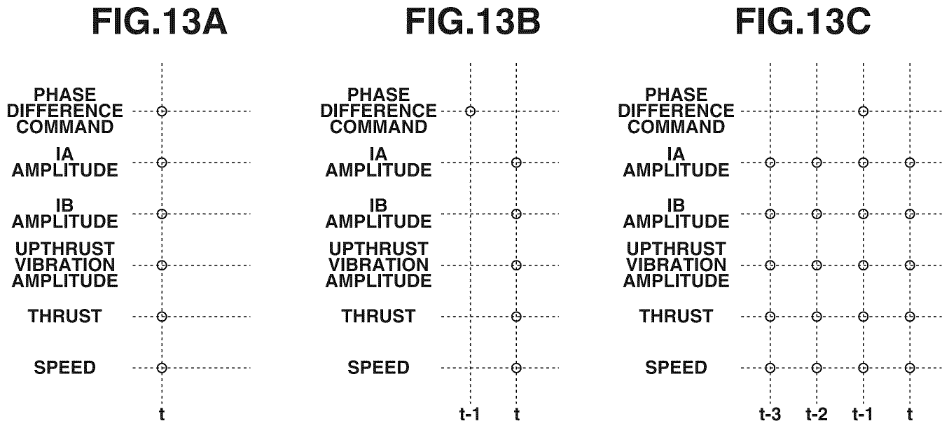

FIGS. 13A, 13B, and 13C are diagrams each illustrating an example of time history data which is used for a learning operation of the NN 20.

FIG. 13A illustrates an operation for performing learning with use of a phase difference command at time t and state quantities, such as the IA amplitude, the IB amplitude, the upthrust vibration amplitude, and the thrust and speed, measured at that time. The thrust is an output value of the thrust sensor 43, and the speed is an output value of the speed sensor 42. FIG. 13A illustrates performing learning in such a manner that various state quantities measured at time t are input to the NN 20 and the NN 20 outputs the value of a phase difference command at time t set by the CPU 37.

FIG. 13B illustrates performing learning in such a manner that various state quantities measured at time t are input to the NN 20 and the NN 20 outputs the value of a phase difference command at time t-1 set by the CPU 37.

FIG. 13C illustrates performing learning in such a manner that state quantities measured at time t-3 to time t are input to the NN 20 and the NN 20 outputs the value of a phase difference command at time t-1 set by the CPU 37.

When the trained NN 20 is used, instead of the state quantities of thrust and speed, a thrust command signal and a speed command signal are connected to the NN 20.

The operation illustrated in FIG. 13C is equivalent to the case of using a neural network 20 in which time-series data such as that illustrated in FIG. 9B is input to the input layer 34. The configuration using such time-series data enables configuring a neural network 20 capable of controlling thrust and speed with a broad frequency band.

Moreover, even when the method of learning illustrated in FIGS. 13A and 13B is used, using a recurrent neural network such as that illustrated in FIG. 9C may result in a frequency band broadening.

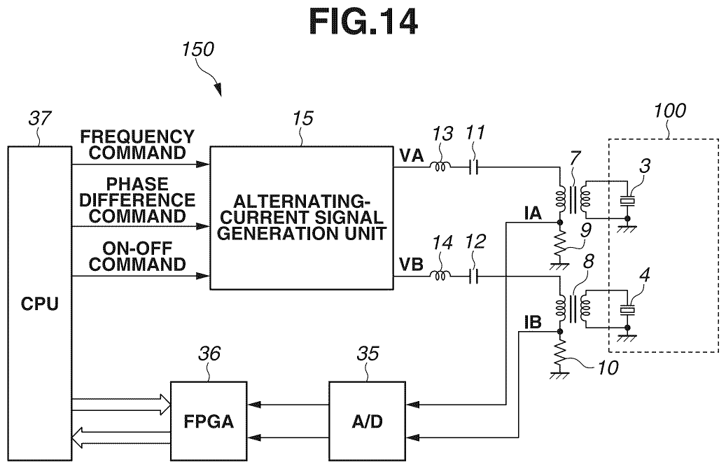

FIG. 14 is a diagram illustrating another configuration example of the drive device 150 for the vibration-type actuator 100. The drive device 150 illustrated in FIG. 14 is a device obtained by removing the amplitude detection units 16 to 18, the addition unit 19, and the NN 20 and adding an analog-to-digital (A/D) conversion unit 35, an field-programmable gate array (FPGA) 36, and a CPU 37 with respect to the drive device 150 illustrated in FIG. 2.

In the configuration illustrated in FIG. 14, the CPU 37 is in charge of the NN 20 and the units for generating a phase difference command and a frequency command illustrated in FIG. 2. Furthermore, in the configuration illustrated in FIG. 14, constituent elements similar to the constituent elements illustrated in FIG. 2 are assigned the respective same reference characters as those in FIG. 2 and the detailed description thereof is omitted here.

The A/D conversion unit 35 converts the waveforms of the current signal IA and the current signal IB from analog to digital. The FPGA 36 receives, as inputs, the signal waveforms detected by the A/D conversion unit 35, detects the respective amplitudes of the current signals IA and IB and the amplitude of a signal obtained by adding the current signal IA and the current signal IB together, and outputs the detected amplitudes to the CPU 37. Moreover, the FPGA 36 includes, inserted therein, a band-pass filter which, before detection of the respective amplitudes, removes a harmonic component and a direct-current component included in each of the current signal IA and the current signal IB.

The CPU 37 sets a phase difference command based on the amplitudes of the current signals IA and IB and a signal obtained by adding them output from the FPGA 36 and command values of thrust and speed with use of an arithmetic routine for performing an arithmetic operation similar to that in the NN 20 illustrated in FIG. 2.

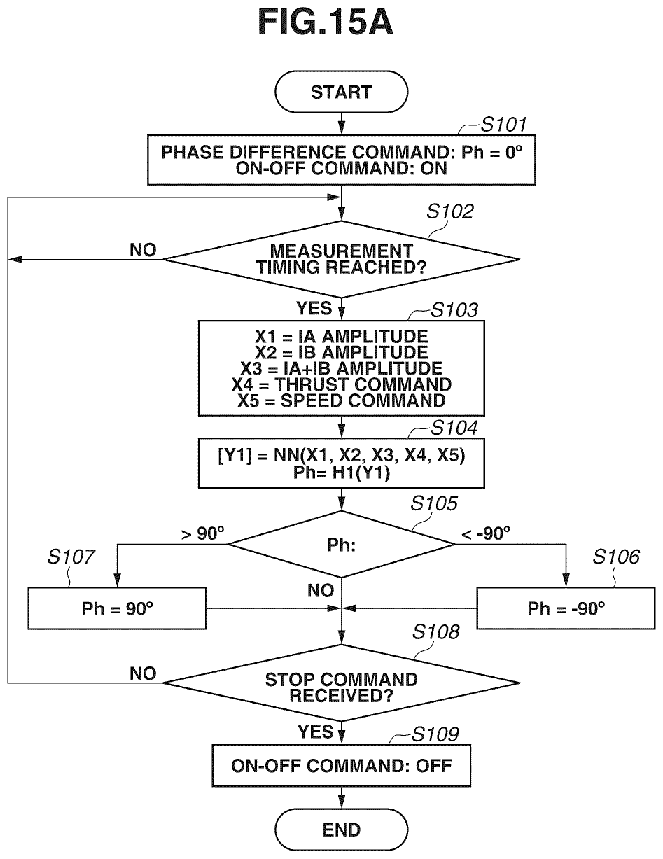

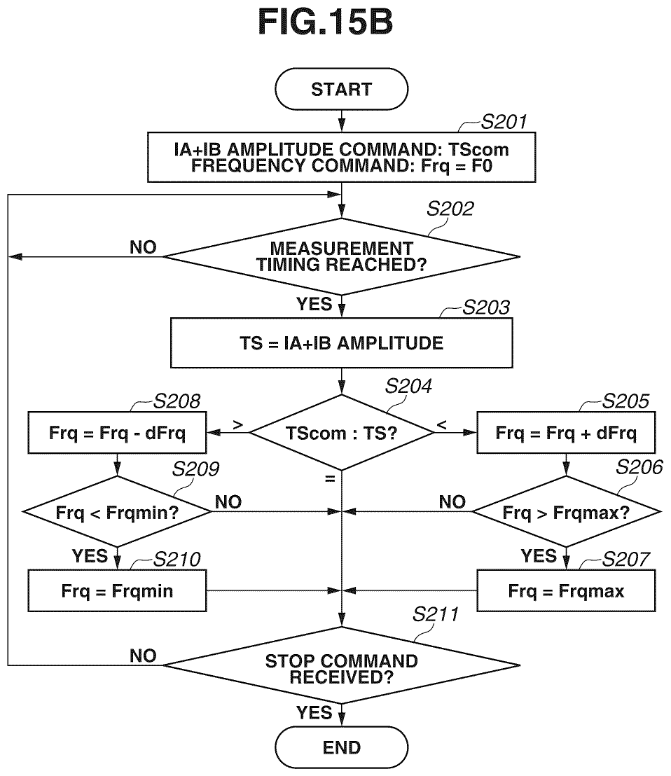

FIGS. 15A and 15B are flowcharts illustrating an operation in which the CPU 37 operates the phase difference command and the frequency command. FIG. 15A illustrates processing including control steps for controlling a thrust, and FIG. 15B illustrates processing including control steps for controlling the upthrust vibration amplitude.

First, the flowchart of FIG. 15A is described. In step S101, the CPU 37 sets a phase difference command Ph to an initial phase difference of 0° and sets an ON-OFF command to ON.

Next, in step S102, the CPU 37 determines whether a measurement timing has been reached. If it is determined that the measurement timing has not yet been reached (NO in step S102), the CPU 37 returns the processing to step S102.

On the other hand, if, in step S102, it is determined that the measurement timing has been reached (YES in step S102), the CPU 37 advances the processing to step S103.

In step S103, the CPU 37 sets respective values to the input layers X1 to X5 of the neural network. The CPU 37 sets the amplitude of the current signal IA to the input layer X1, sets the amplitude of the current signal IB to the input layer X2, sets the amplitude of a signal obtained by adding the current signal IA and the current signal IB together to the input layer X3, sets the thrust command to the input layer X4, and sets the speed command to the input layer X5. Furthermore, the control routine for upthrust vibration amplitude illustrated in FIG. 15B is performed in parallel with the control routine for thrust illustrated in FIG. 15A.

Next, in step S104, the CPU 37 sets the phase difference command Ph with use of an arithmetic routine for the trained neural network 20 according to the values for the input layers X1 to X5 set in step S103. In subsequent steps, the CPU 37 performs limitation in such a manner that the phase difference command Ph does not exceed ±90°.

In step S105, the CPU 37 compares the phase difference command Ph and ±90°, which is a phase difference limit value, with each other.

If, in step S105, it is determined that the phase difference command Ph is less than −90° (<−90° in step S105), the CPU 37 advances the processing to step S106.

In step S106, the CPU 37 sets −90° to the phase difference command Ph, and then advances the processing to step S108.

Moreover, if, in step S105, it is determined that the phase difference command Ph is greater than 90° (>90° in step S105), the CPU 37 advances the processing to step S107.

In step S107, the CPU 37 sets 90° to the phase difference command Ph, and then advances the processing to step S108.

Moreover, if, in step S105, it is determined that the phase difference command Ph is otherwise (−90°≤Ph≤90° (NO in step S105), the CPU 37 advances the processing to step S108.

In step S108, the CPU 37 determines whether a stop command has been input.

If it is determined that the stop command has not yet been input (NO in step S108), the CPU 37 returns the processing to step S102, thus performing processing operations in step S102 and subsequent steps.

On the other hand, in step S108, it is determined that the stop command has been input (YES in step S108), the CPU 37 advances the processing to step S109.

In step S109, the CPU 37 sets the ON-OFF command to OFF. With this setting, the alternating-current signal VA and the alternating-current signal VB which the alternating-current signal generation unit 15 outputs become 0 volts (V), so that the contact body (slider) 6 of the vibration-type actuator 100 stops.

Then, when the processing operation in step S109 ends, the processing in the flowchart illustrated in FIG. 15A ends.

Next, the flowchart of FIG. 15B is described. First, in step S201, the CPU 37 sets a previously determined upthrust vibration amplitude command TScom, and sets a frequency command Frq to an initial frequency F0.

Next, in step S202, the CPU 37 determines whether a measurement timing has been reached. If it is determined that the measurement timing has not yet been reached (NO in step S202), the CPU 37 returns the processing to step S202.

On the other hand, if, in step S202, it is determined that the measurement timing has been reached (YES in step S202), the CPU 37 advances the processing to step S203.

In step S203, the CPU 37 acquires, from the FPGA 36, an upthrust vibration amplitude TS, which is the amplitude of a signal obtained by adding the current signal IA and the current signal IB together.

Then, in subsequent steps, the CPU 37 compares the above-mentioned upthrust vibration amplitude command TScom and the upthrust vibration amplitude TS detected in step S203 with each other, and thus performs control of the frequency command Frq.

Next, the control of the frequency command Frq is described with reference to step S204 to step S210.

In step S204, the CPU 37 compares the upthrust vibration amplitude command TScom set in step S201 and the upthrust vibration amplitude TS detected in step S203 with each other.

If, as a result of comparison in step S204, it is determined that the upthrust vibration amplitude command TScom is smaller than the upthrust vibration amplitude TS (<in step S204), the CPU 37 advances the processing to step S205.

In step S205, the CPU 37 adds a previously determined value dFrq to the frequency command Frq.

Next, in step S206, the CPU 37 determines whether the frequency command Frq is larger than an upper limit value Frqmax.

If, in step S206, it is determined that the frequency command Frq is larger than the upper limit value Frqmax (YES in step S206), the CPU 37 advances the processing to step S207. If it is determined that the frequency command Frq is not larger than the upper limit value Frqmax (NO in step S206), the CPU 37 advances the processing to step S211.

In step S207, the CPU 37 sets the frequency command Frq to the upper limit value Frqmax, and then advances the processing to step S211.

Moreover, if, as a result of comparison in step S204, it is determined that the upthrust vibration amplitude command TScom is larger than the upthrust vibration amplitude TS (> in step S204), the CPU 37 advances the processing to step S208.

In step S208, the CPU 37 subtracts a previously determined value dFrq from the frequency command Frq.

Next, in step S209, the CPU 37 determines whether the frequency command Frq is smaller than a lower limit value Frqmin.

If, in step S209, it is determined that the frequency command Frq is smaller than the lower limit value Frqmin (YES in step S209), the CPU 37 advances the processing to step S210. If it is determined that the frequency command Frq is not smaller than the lower limit value Frqmin (NO in step S209), the CPU 37 advances the processing to step S211.

In step S210, the CPU 37 sets the frequency command Frq to the lower limit value Frqmin, and then advances the processing to step S211.

In a case where the processing operation in step S207 ends, in case where the processing operation in step S210 ends, or if, as a result of comparison in step S204, it is determined that the upthrust vibration amplitude command TScom and the upthrust vibration amplitude TS are equal to each other (=in step S204), the CPU 37 advances the processing to step S211.

Furthermore, by repeating the processing operations in step S204 to step S210, the frequency command Frq is controlled in such a manner that the upthrust vibration amplitude TS comes close to the upthrust vibration amplitude command TScom.

Next, in step S211, the CPU 37 determines whether a stop command has been input. If, in step S211, it is determined that the stop command has not yet been input (NO in step S211), the CPU 37 returns the processing to step S202, thus performing processing operations in step S202 and subsequent steps.

On the other hand, if, in step S211, it is determined that the stop command has been input (YES in step S211), the processing in the flowchart illustrated in FIG. 15B ends.

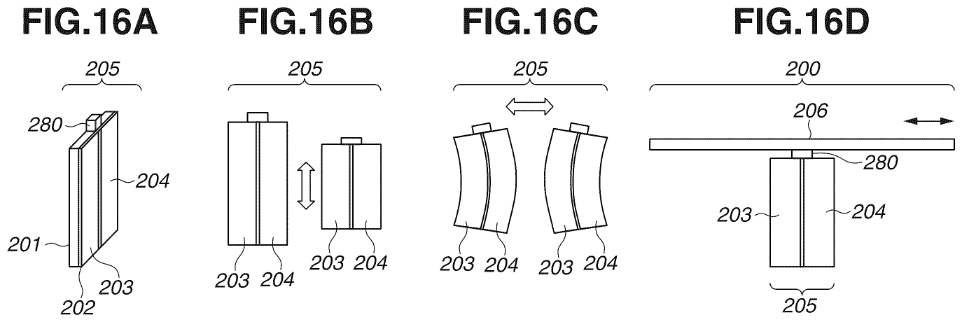

FIGS. 16A, 16B, 16C, and 16D are diagrams illustrating examples of a configuration and a vibration shape of a vibration-type actuator 200. The configuration and operating principle of the vibration-type actuator 200 according to the first exemplary embodiment are described with reference to FIGS. 16A to 16D.

The vibration-type actuator 200 according to the first exemplary embodiment is configured to include, as illustrated in FIG. 16D, a vibrating body 205 and a contact body 206. The vibrating body 205 is a plate-like vibrating body made from a conductive material, and is configured with, as illustrated in FIG. 16A and FIG. 16D, a piezoelectric element 202 and an elastic body 201, which has, on the plate-like surface thereof, a projection portion 280 which is in contact with the contact body 206. The piezoelectric element 202 constitutes a part of the vibrating body 205, and is a component portion for causing the vibrating body 205 to vibrate.

Moreover, on the surface of the piezoelectric element 202, as illustrated in FIG. 16A, two electrodes 203 and 204 are formed. The two electrodes 203 and 204 are made to be electrodes the space between which is electrically insulated, and two alternating-current voltages the phase of each of which is able to independently change are applied to the two electrodes 203 and 204. Moreover, the whole surface of the reverse side of the piezoelectric element 202 is made to be an electrode, and is configured to allow the ground potential to be connected thereto from the obverse side of the piezoelectric element 202 through a via (via hole) (not illustrated) provided in a part of the piezoelectric element 202. In the following description, the electrodes 203 and 204 are referred to as a “piezoelectric body 203” and a “piezoelectric body 204”, respectively.

The contact body 206 illustrated in FIG. 16D is a slider which is in pressed contact with the projection portion 280 of the vibrating body 205 at a fixed pressure force by a pressure mechanism (not illustrated). The contact body (slider) 206 is configured to be relatively moved in directions indicated by a double-headed arrow (in rightward and leftward directions) in FIG. 16D by vibrations excited by the vibrating body 205.

FIGS. 16B and 16C are diagrams illustrating examples of vibration modes of the vibrating body 205.

FIG. 16B illustrates the vibration shape (stretching vibration) of a vibration mode which is excited by the vibrating body 205 when alternating-current voltages which are identical in amplitude and phase are applied to the piezoelectric body 203 and the piezoelectric body 204 (an upthrust vibration mode).

Moreover, FIG. 16C illustrates the vibration shape (bending vibration) of a vibration mode which is excited by the vibrating body 205 when alternating-current voltages which are identical in amplitude and opposite in phase are applied to the piezoelectric body 203 and the piezoelectric body 204 (an advancing vibration mode).

Thus, when the phase difference between alternating-current voltages which are applied to the piezoelectric body 203 and the piezoelectric body 204 of the vibrating body 205 is set to 0°, a vibration in the vibration mode illustrated in FIG. 16B (upthrust vibration mode) is excited. Moreover, when the phase difference between alternating-current voltages which are applied to the piezoelectric body 203 and the piezoelectric body 204 of the vibrating body 205 is set to 180°, a vibration in the vibration mode illustrated in FIG. 16C (advancing vibration mode) is excited.

Additionally, when the phase difference between alternating-current voltages which are applied to the piezoelectric body 203 and the piezoelectric body 204 of the vibrating body 205 is set to a phase difference other than 0° and 180° (in actuality, about a range of ±120° from 0° being used), both the vibration modes illustrated in FIGS. 16B and 16C are simultaneously excited. In this case, the contact body (slider) 206, which is in pressed contact with the projection portion 280 provided in the vibrating body 205, moves in the transverse direction of a rectangle of the vibrating body 205. Then, as the phase difference is more away from 0°, the amplitude in the vibration mode illustrated in FIG. 16C (advancing vibration mode) becomes larger, so that the relative speed between the contact body (slider) 206 and the vibrating body 205 increases.

If the piezoelectric bodies 203 and 204 are replaced with the above-mentioned piezoelectric bodies 3 and 4, the drive device 150 for the vibration-type actuator 100 according to the above-described first exemplary embodiment can be applied.

While, in the above-described example, the amplitude of a sum signal of the current signal IA and the current signal IB is set as an upthrust vibration amplitude, depending on a structure of the vibration-type actuator, the amplitude of a difference signal between the current signal IA and the current signal IB may be set as an upthrust vibration amplitude.

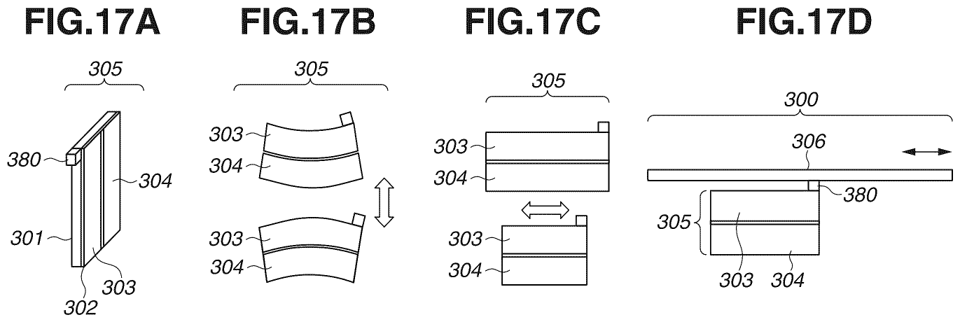

FIGS. 17A, 17B, 17C, and 17D are diagrams illustrating a configuration example of a vibration-type actuator 300. The vibration-type actuator 300 uses the same vibration modes as those in the vibration-type actuator 200, but differs from the vibration-type actuator 200 in the position of a projection portion 380 which is in contact with a contact body 306 and in that the amplitude of “the current signal IA−the current signal IB” corresponds to the upthrust vibration amplitude.

The vibration-type actuator 300 is configured to include, as illustrated in FIG. 17D, a vibrating body 305 and the contact body 306. The vibrating body 305 is a plate-like vibrating body made from a conductive material, and is configured with, as illustrated in FIG. 17A and FIG. 17D, a piezoelectric element 302 and an elastic body 301, which has, on the plate-like surface thereof, the projection portion 380 which is in contact with the contact body 306. The piezoelectric element 302 constitutes a part of the vibrating body 305, and is a component portion for causing the vibrating body 305 to vibrate.

Moreover, on the surface of the piezoelectric element 302, as illustrated in FIG. 17A, two electrodes 303 and 304 are formed. The two electrodes 303 and 304 are made to be electrodes the space between which is electrically insulated, and two alternating-current voltages the phase of each of which is able to independently change are applied to the two electrodes 303 and 304. Moreover, the whole surface of the reverse side of the piezoelectric element 302 is made to be an electrode, and is configured to allow the ground potential to be connected thereto from the obverse side of the piezoelectric element 302 through a via (via hole) (not illustrated) provided in a part of the piezoelectric element 302. In the following description, the electrodes 303 and 304 are referred to as a “piezoelectric body 303” and a “piezoelectric body 304”, respectively.

FIGS. 17B and 17C are diagrams illustrating examples of vibration modes of the vibrating body 305.

FIG. 17B illustrates the vibration shape (bending vibration) of a vibration mode which is excited by the vibrating body 305 when alternating-current voltages which are identical in amplitude and opposite in phase are applied to the piezoelectric body 303 and the piezoelectric body 304 (an upthrust vibration mode). Moreover, FIG. 17C illustrates the vibration shape (stretching vibration) of a vibration mode which is excited by the vibrating body 305 when alternating-current voltages which are identical in amplitude and phase are applied to the piezoelectric body 303 and the piezoelectric body 304 (an advancing vibration mode).

Although both the speed command and the thrust command are input to the NN20 in the above example, the present disclosure is not limited to this, and either of the speed command and the thrust command can be input to the NN20.

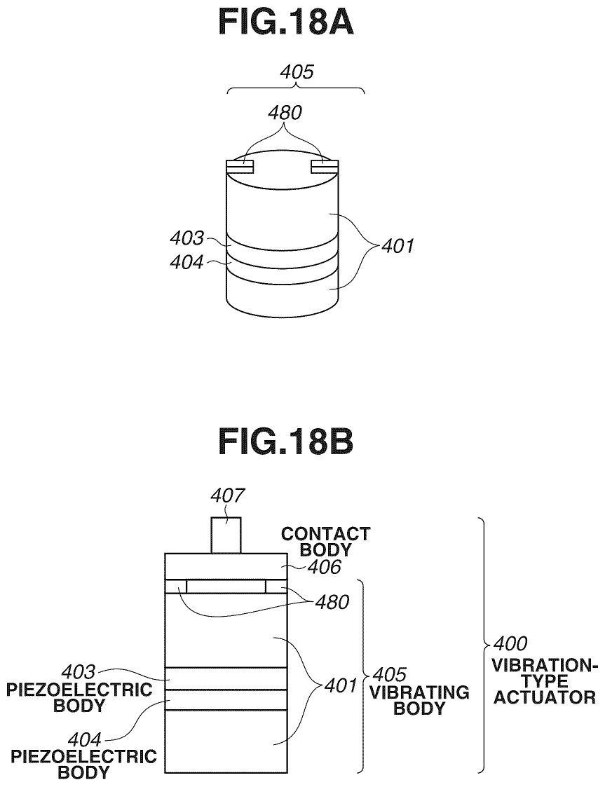

FIGS. 18A and 18B are diagrams illustrating an example of a configuration of a vibration-type actuator 400 according to a second exemplary embodiment. The configuration and operating principle of the vibration-type actuator 400 according to the second exemplary embodiment are described with reference to FIGS. 18A and 18B.

The vibration-type actuator 400 according to the second exemplary embodiment is configured to include, as illustrated in FIG. 18B, a vibrating body 405, a contact body 406, and a rotational shaft 407 connected to the contact body 406.

As illustrated in FIG. 18A, the vibrating body 405 is a cylindrical vibrating body made from a conductive material, and is configured with a piezoelectric body 403, a piezoelectric body 404, and elastic bodies 401, which sandwich the piezoelectric body 403 and the piezoelectric body 404 from above and below and have projection portions 480 on the upper portion of the cylinder of the vibrating body 405. Moreover, the piezoelectric body 403 is a component portion which adds a vibration for elongating and contracting the vibrating body 405 in the direction of the height of the cylinder of the vibrating body 405, the piezoelectric body 404 is a component portion which adds a torsional vibration to the vibrating body 405 toward the central axis of the cylinder of the vibrating body 405, and the piezoelectric body 403 and the piezoelectric body 404 are sandwiched and fixed between the elastic bodies 401 by a clamping member (not illustrated).

The contact body 406 illustrated in FIG. 18B is a rotor which is in pressed contact with the projection portions 480 of the vibrating body 405 at a fixed pressure force by a pressure mechanism (not illustrated). The contact body (rotor) 406 is rotated by a vibration which is excited at the vibrating body 405, thus rotating the rotational shaft 407 together with the contact body (rotor) 406.

Next, the driving operation of the vibration-type actuator 400 is described. The vibration-type actuator 400 is an actuator which rotationally drives the contact body (rotor) 406 by a composite vibration composed of a stretching vibration (upthrust vibration) and a torsional vibration (advancing vibration) which are excited at the vibrating body 405.

When an alternating-current voltage with a predetermined frequency is applied to the piezoelectric body 403, a stretching vibration (upthrust vibration) is excited at the vibrating body 405, and, when an alternating-current voltage is applied to the piezoelectric body 404, a torsional vibration (advancing vibration) is excited at the vibrating body 405. Therefore, when the stretching vibration (upthrust vibration) and the torsional vibration (advancing vibration) are excited with the phases thereof being temporally shifted from each other, the contact body (rotor) 406 rotates.

Here, differences between the vibration-type actuator 400 and the vibration-type actuator 100 are described. Between these vibration-type actuators 100 and 400, in addition to a difference in shape, there is a large difference in driving. This difference is that, while the vibration-type actuator 100 excites an upthrust vibration by an in-phase component of applied two-phase alternating-current voltages and excites an advancing vibration by an opposite-phase component thereof, each phase of the two-phase alternating-current voltages applied to the vibration-type actuator 400 is individually associated with the upthrust vibration and the advancing vibration.

Therefore, while the vibration-type actuator 100 controls the amplitude balance of an upthrust vibration and an advancing vibration by a phase difference between the applied two-phase alternating-current voltages, in the case of the vibration-type actuator 400, even if the phase difference is operated, the amplitude balance of an upthrust vibration and an advancing vibration does not change. Therefore, the vibration-type actuator 400 controls the balance of an upthrust vibration and an advancing vibration by operating the amplitude balance of two-phase alternating-current voltages or the voltage amplitude of one of the two phases.

Next, the vibration excitation to the vibrating body 405 attributable to an external force of the vibration-type actuator 400 is described. An example in which driving is performed on the condition that the frequencies of the two-phase alternating-current voltages are higher than the natural frequency in the upthrust vibration mode of the vibrating body 405 is described. Even in the vibration-type actuator 400, the second vibrational component is superposed on the vibrating body 405 by a force which is generated at a contact portion according to the relative speed and relative force between the projection portions 480 and the contact body (rotor) 406.

FIG. 19 is a diagram illustrating a configuration example of a drive device 450 for the vibration-type actuator 400 according to the second exemplary embodiment.

The drive device 450 includes, as with the drive device 150 illustrated in FIG. 2, transformers 7 and 8, resistors 9 and 10, capacitors 11 and 12, inductors 13 and 14, an alternating-current signal generation unit 15, amplitude detection units 16 to 18, an addition unit 19, an NN 20, and a subtraction unit 38.

The secondary side winding wire of the transformer 7 is connected to the piezoelectric body 403. The secondary side winding wire of the transformer 8 is connected to the piezoelectric body 404.

The addition unit 19 outputs a signal obtained by adding the current signal IA and the current signal IB together. The amplitude detection unit 16 detects the amplitude of a signal output from the addition unit 19, and outputs the detected amplitude to the input layer X1.

The subtraction unit 38 outputs a signal obtained by subtracting the current signal IB from the and the current signal IA. The amplitude detection unit 17 detects the amplitude of a signal output from the subtraction unit 38, and outputs the detected amplitude to the input layer X2.

The amplitude detection unit 18 detects the amplitude of the current signal IA, and outputs the detected amplitude to the input layer X3. The input layer X4 receives, as an input, a torque command from the command unit (not illustrated). The input layer X5 receives, as an input, a speed command from the command unit (not illustrated). The output layer Y1 outputs a VB voltage amplitude command to the alternating-current signal generation unit 15.

First, the generation unit for alternating-current voltages is described. The alternating-current signal generation unit 15 generates two-phase alternating-current signal (first signal) VA and alternating-current signal (second signal) VB different in phase by 90° based on a frequency command which is output from the command unit (not illustrated) and a VB voltage amplitude command which is output from the NN 20.

The alternating-current signal generation unit 15 sets the alternating-current signal VA to a predetermined amplitude and sets the alternating-current signal VB to an amplitude corresponding to the VB voltage amplitude command, and, in a case where the VB voltage amplitude command is a negative value, the alternating-current signal generation unit 15 inverts the alternating-current signal VB between positive and negative and outputs the inverted alternating-current signal VB.

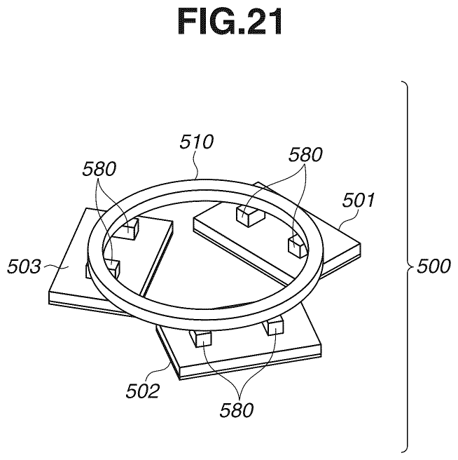

FIGS. 20A and 20B are diagrams illustrating examples of waveforms of the alternating-current signal VA, the alternating-current signal VB, and the VB voltage amplitude command. FIG. 20A illustrates a signal waveform of the alternating-current signal VA. FIG. 20B illustrates signal waveforms of the alternating-current signal VB (solid line) and the VB voltage amplitude command (dashed line). The alternating-current signal VB is shifted in phase by 90° relative to the alternating-current signal VA, and the sign of a phase difference between the alternating-current signal VA and the alternating-current signal VB is switched by the sign of the VB voltage amplitude command (dashed line).

Referring to FIG. 19, the alternating-current signal VA and the alternating-current signal VB are connected to the primary side winding wires of the transformer 7 and the transformer 8 via series resonance circuits composed of the inductors 13 and 14 and the capacitors 11 and 12, respectively. Then, the voltages input to the primary side winding wires of the transformer 7 and the transformer 8 are boosted, and are then applied, as a first drive voltage and a second drive voltage, to the piezoelectric body 403 and the piezoelectric body 404 of the vibration-type actuator 400 connected to the secondary side winding wires of the transformer 7 and the transformer 8, respectively.

Here, the inductor values of the secondary side winding wires of the transformer 7 and the transformer 8 are frequency-matched with the braking capacities of the piezoelectric body 403 and the piezoelectric body 404. This causes currents approximately proportional to the vibration speeds of the piezoelectric body 403 and the piezoelectric body 404 to flow through the primary side winding wires of the transformer 7 and the transformer 8.

On the other hand, the resistors 9 and 10 are connected in series to the primary side winding wires of the transformer 7 and the transformer 8. The resistors 9 and 10 are used to convert currents flowing through the primary side winding wires of the connected transformers 7 and 8 into voltages, thus generating a current signal IA and a current signal IB. Then, the current signal IA is a signal associated with the vibration in the stretching vibration mode (upthrust vibration mode) of the vibrating body 405, and the current signal IB is a signal associated with the torsional vibration mode (advancing vibration mode) of the vibrating body 405.

Next, a configuration related to the control of torque and speed is described. While, to detect the amplitude of the upthrust vibration of the vibration-type actuator 100 illustrated in FIG. 2, the amplitude of “the current signal IA+the current signal IB” is detected, in the case of the vibration-type actuator 400, the amplitude of the current signal IA is equivalent to the amplitude of the upthrust vibration.

In the configuration illustrated in FIG. 19, instead of the amplitude of the current signal IA illustrated in FIG. 2, the amplitude of “the current signal IA+the current signal IB” is detected, instead of the amplitude of the current signal IB illustrated in FIG. 2, the amplitude of “the current signal IA−the current signal IB” is detected, and, instead of the amplitude of “the current signal IA+the current signal IB” illustrated in FIG. 2, the amplitude of the current signal IA is detected.

The amplitude detection unit 16 receives, as an input, “the current signal IA+the current signal IB” output from the addition unit 19, and outputs the amplitude of the received signal. The amplitude detection unit 17 receives, as an input, “the current signal IA−the current signal IB” output from the subtraction unit 38, and outputs the amplitude of the received signal. The amplitude detection unit 18 outputs the amplitude of the current signal IA.

These amplitudes are changed by the second vibrational component, which is superposed on the vibrating body 405 according to the torque and speed. Then, the VB voltage amplitude command is output by the NN 20, which has been caused to preliminarily perform learning with inputting of the amplitude values output from the amplitude detection units 16 to 18 and the speed and torque.

Then, the alternating-current signal generation unit 15 sets the voltage amplitude of the alternating-current signal VB, so that the speed and torque are controlled according to the magnitude of the amplitude in the advancing vibration mode excited at the vibrating body 405.

Furthermore, while both a speed command and a thrust command are input to the NN 20, only one of them can be input to the NN 20.

The input layer X1 receives, as an input, the detected value of the amplitude of a signal obtained by adding the current signal IA, which is based on a current flowing through the primary side winding wire of the transformer 7, and the current signal IB, which is based on a current flowing through the primary side winding wire of the transformer 8, together from the amplitude detection unit 16.

The input layer X2 receives, as an input, the detected value of the amplitude of a signal obtained by subtracting the current signal IB, which is based on a current flowing through the primary side winding wire of the transformer 8, from the current signal IA, which is based on a current flowing through the primary side winding wire of the transformer 7, from the amplitude detection unit 17.

The input layer X3 receives, as an input, the detected value of the amplitude of the current signal IA, which is based on a current flowing through the primary side winding wire of the transformer 7, from the amplitude detection unit 18.

The input layer X4 receives, as an input, a torque command from the command unit. The torque command is a command value for a torque occurring between the vibrating body 405 and the contact body 406.

The input layer X5 receives, as an input, a speed command from the command unit. The speed command is a command value for a relative speed of the contact body 406 with respect to the vibrating body 405.

As illustrated in FIG. 20A, the amplitude of the alternating-current signal VA, which is to be supplied to the primary side winding wire of the transformer 7, is constant. The output layer Y1 outputs the VB voltage amplitude command to the alternating-current signal generation unit 15. The VB voltage amplitude command is a command for the amplitude of the alternating-current signal VB, which is to be supplied to the primary side winding wire of the transformer 8.

The alternating-current signal generation unit 15 generates the alternating-current signal VB based on the VB voltage amplitude command.

FIG. 21 is a diagram illustrating a configuration example of a vibration-type actuator 500 according to a third exemplary embodiment. The vibration-type actuator 500 includes vibrating bodies 501, 502, and 503, a contact body 510, and projection portions 580.

The vibrating bodies 501, 502, and 503, each of which corresponds to the vibrating body 5 illustrated in FIGS. 1A to 1E, are in contact with the annular contact body 510 at the respective contact surfaces of the projection portions 580 of the vibrating bodies 501, 502, and 503 along the circumference of the annular contact body 510. The thrusts of the three vibrating bodies 501, 502, and 503 being added in combination increase an output torque of the vibration-type actuator 500.

FIG. 22 is a diagram illustrating a configuration example of the drive device 550 for the vibration-type actuator 500 according to the third exemplary embodiment. Constituent elements similar to the constituent elements illustrated in FIG. 2 are assigned the respective same reference characters as those in FIG. 2, and the detailed description thereof is omitted here.

The drive device 550 includes transformers 60 to 65, resistors 9 and 10, capacitors 11 and 12, inductors 13 and 14, an alternating-current signal generation unit 15, amplitude detection units 16 to 18, an addition unit 19, and an NN 20.

The vibrating body 501 is provided with piezoelectric bodies 504 and 505, the vibrating body 502 is provided with piezoelectric bodies 506 and 507, and the vibrating body 503 is provided with piezoelectric bodies 508 and 509, each serving as a piezoelectric body for vibration excitation. The respective piezoelectric bodies are divided into A-phase side piezoelectric bodies, which are connected to the alternating-current signal VA via the inductor 13, the capacitor 11, and the three transformers 60 to 62, and B-phase side piezoelectric bodies, which are connected to the alternating-current signal VB via the inductor 14, the capacitor 12, and the three transformers 63 to 65. The A-phase side piezoelectric bodies include the piezoelectric bodies 504, 506, and 508, which are connected to the secondary side winging wires of the transformers 60, 61, and 62, respectively. Then, the primary side winding wires of the transformers 60, 61, and 62 are connected in series, in which one end of the series connection is connected to the capacitor 11 and the other end thereof is connected to the resistor 9 for current detection.

On the other hand, the B-phase side piezoelectric bodies include the piezoelectric bodies 505, 507, and 509, which are connected to the secondary side winging wires of the transformers 63, 64, and 65, respectively. Then, the primary side winding wires of the transformers 63, 64, and 65 are connected in series, in which one end of the series connection is connected to the capacitor 12 and the other end thereof is connected to the resistor 10 for current detection.

Then, the resistor 9 is used to detect the current signal IA corresponding to the vibration speed of the A-phase side piezoelectric bodies, and the resistor 10 is used to detect the current signal IB corresponding to the vibration speed of the B-phase side piezoelectric bodies.

Since the vibrating bodies 501, 502, and 503 are driven with series connection, when alternating-current voltages are applied to the primary side winding wires of the transformers 60 to 65, well uniform vibrations are formed. Moreover, the second vibrational components, which are superposed on the respective vibrating bodies 501, 502, and 503 by vibrations caused by frictional force acting between the projection portions 580 of the vibrating bodies 501, 502, and 503 and the contact body (rotor) 510, also change well uniformly. Since the vibrations of the vibrating bodies 501, 502, and 503 are well uniform, as with the first exemplary embodiment, detecting the currents on the primary side winding wires of the transformers 60 to 65 enables detecting vibrations of the vibrating bodies 501, 502, and 503 as a single vibration.

Thus, even in the third exemplary embodiment, in which the vibrating bodies 501, 502, and 503 are plurally connected in series to be driven, the NN 20 described in the first exemplary embodiment can be used to control the torque and speed. In the third exemplary embodiment, the NN 20, which has been preliminarily caused to perform learning in such a way as to control speed and torque, is used to operate a phase difference command and control speed and torque.

While, in the third exemplary embodiment, an example in which a plurality of vibrating bodies 501, 502, and 503 is connected to the transformers 60 to 65 and is connected in series and voltages are applied to both ends of the plurality of vibrating bodies 501, 502, and 503 has been described, piezoelectric bodies of a plurality of vibrating bodies 501, 502, and 503 can be directly connected in series without via transformers 60 to 65. Moreover, while, in the above-mentioned example, vibrations are detected with the currents on the primary side wiring wires of the transformers 60 to 65, a piezoelectric element for vibration detection can be separately provided in a vibrating body.

The input layer X1 receives, as an input, the detected value of the amplitude of the current signal IB, which is based on a current flowing through the primary side winding wires of the transformers 63 to 65, from the amplitude detection unit 16.

The input layer X2 receives, as an input, the detected value of the amplitude of the current signal IA, which is based on a current flowing through the primary side winding wires of the transformers 60 to 62, from the amplitude detection unit 17.

The input layer X3 receives, as an input, the detected value of the amplitude of a signal obtained by adding the current signal IA, which is based on a current flowing through the primary side winding wires of the transformers 60 to 62, and the current signal IB, which is based on a current flowing through the primary side winding wires of the transformers 63 to 65, together from the amplitude detection unit 18.

The input layer X4 receives, as an input, a torque command from the command unit. The torque command is a command value for a torque occurring between the vibrating bodies 501 to 503 and the contact body 510.

The input layer X5 receives, as an input, a speed command from the command unit. The speed command is a command value for a relative speed of the contact body 510 with respect to the vibrating bodies 501 to 503.

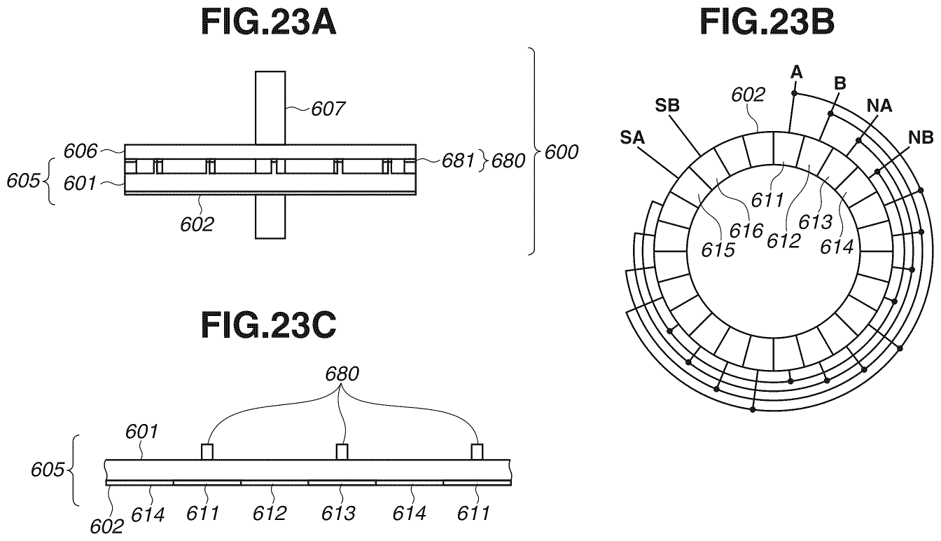

FIG. 23A is a diagram illustrating a configuration example of a vibration-type actuator 600 according to a fourth exemplary embodiment.

The vibration-type actuator 600 according to the fourth exemplary embodiment includes a vibrating body 605, a contact body 606, which is an annular rotor, and a rotational shaft 607 connected to the contact body (rotor) 606. The vibrating body 605 is an annular vibrating body made from a conductive material, and is configured with a piezoelectric element 602 and an elastic body 601, which has, on a circular ring thereof, projection portions 680 which are in contact with the contact body (rotor) 606. Moreover, each of the projection portions 680 has a friction member 681 made from resin on a contact portion thereof with the contact body (rotor) 606. Moreover, the piezoelectric element 602 constitutes a part of the vibrating body 605, and is a component portion for causing the vibrating body 605 to vibrate.

FIG. 23B is a diagram illustrating examples of a plurality of electrode structures and electrical connection wirings which are configured in the piezoelectric element 602 illustrated in FIG. 23A.

As illustrated in FIG. 23B, the piezoelectric element 602 is provided with 24 electrodes arranged at regular intervals on the circumference thereof, and the respective electrodes of the piezoelectric element 602 are electrically connected by connection wirings for every 4 electrodes along the circumference. Here, regions of the piezoelectric element 602 in each of which a group of electrodes connected together is provided are referred to as “piezoelectric bodies 611”, “piezoelectric bodies 612”, “piezoelectric bodies 613”, and “piezoelectric bodies 614” for respective connections.

Moreover, the piezoelectric bodies 611 are arranged at intervals of 60° on the circumference, and, when an alternating-current voltage A is applied, an out-of-plane flexural vibration with 6 waves is formed along the circumference of the vibrating body 605. Additionally, when an alternating-current voltage B, an alternating-current voltage NA, and an alternating-current voltage NB which are sequentially shifted from the alternating-current voltage A by every 90° one by one are applied to the piezoelectric body 612, the piezoelectric body 613, and the piezoelectric body 614, respectively, an out-of-plane progressive vibrational wave with 6 waves is formed on the vibrating body 605. Then, the progressive vibrational wave with 6 waves causes a relative torque to be generated between the projection portions 680 of the vibrating body 605 and the contact body (rotor) 606, thus rotating the contact body (rotor) 606.

Moreover, the piezoelectric element 602 is provided with a plurality of electrodes for vibration detection, and regions of the piezoelectric element 602 in which these electrodes are provided are referred to as a “piezoelectric body 615” and a “piezoelectric body 616”. The piezoelectric body 615 detects vibrations excited by the piezoelectric body 611 and the piezoelectric body 613 and thus outputs a vibration detection signal SA. The piezoelectric body 616 detects vibrations excited by the piezoelectric bodies 612 and the piezoelectric bodies 614 and thus outputs a vibration detection signal SB.

FIG. 23C is a diagram illustrating an example of a positional relationship between the piezoelectric bodies 611 to 614 and the projection portions 680. The projection portions 680 are provided at the respective centers of electrode compartments of each piezoelectric body 611 and each piezoelectric body 613 to which the alternating-current voltage A and the alternating-current voltage NA are connected, respectively. Then, when vibrations caused by the piezoelectric bodies 611 and the piezoelectric bodies 613 are referred to as a “A-phase vibration” and vibrations caused by the piezoelectric bodies 612 and the piezoelectric bodies 614 are referred to as a “B-phase vibration”, the A-phase vibration excites an upthrust vibration for vibrating the projection portions 680 in upward and downward directions on the drawing sheet and the B-phase vibration excites an advancing vibration for vibrating the projection portions 680 in rightward and leftward directions on the drawing sheet.

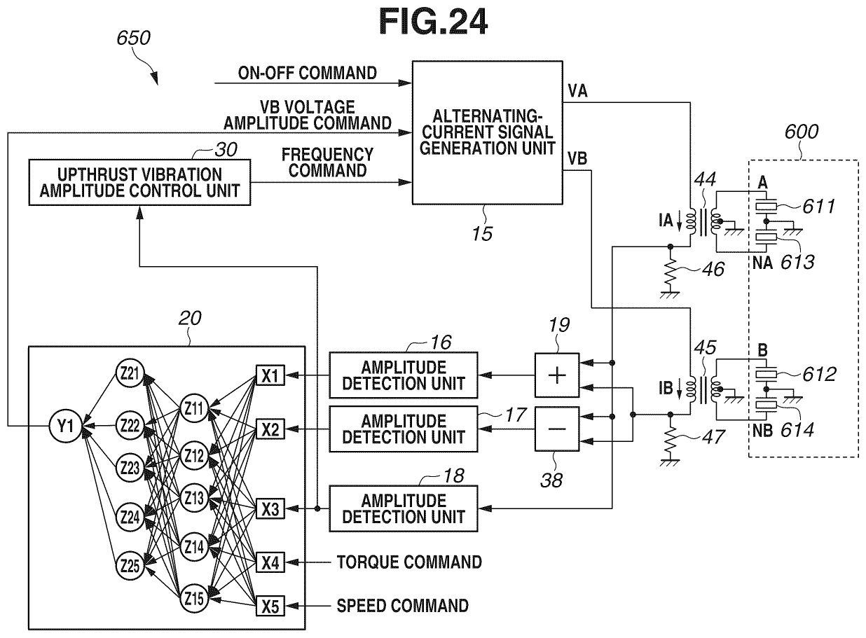

FIG. 24 is a diagram illustrating a configuration example of a drive device 650 for the vibration-type actuator 600 according to the fourth exemplary embodiment. In FIG. 24, constituent elements similar to the constituent elements illustrated in FIG. 19 are assigned the respective same reference characters as those in FIG. 19, and the detailed description thereof is omitted here.

The drive device 650 includes transformers 44 and 45, resistors 46 and 47, an alternating-current signal generation unit 15, amplitude detection units 16 to 18, an addition unit 19, an NN 20, an upthrust vibration amplitude control unit 30, and a subtraction unit 38.

The vibration-type actuator 600 is an actuator which is driven with four-phase alternating-current voltages, and the alternating-current voltage A and the alternating-current voltage NA as well as the alternating-current voltage B and the alternating-current voltage NB are set as opposite-phase alternating-current voltages, the phases of which are opposite each other. The paired piezoelectric bodies 611 and 613 and the paired piezoelectric bodies 612 and 614, to which opposite-phase alternating-current voltages are applied, are connected to the secondary side winding wires, each with a center tap, of the transformers 44 and 45, respectively.

To respective one ends of the primary side winding wires of the transformers 44 and 45, the alternating-current signal VA and the alternating-current signal VB, which are outputs of the alternating-current signal generation unit 15, are applied, respectively, and, to the respective other ends thereof, the resistors 46 and 47 for current detection are connected, respectively.

The resistor 46 and the resistor 47 are used to detect the current signal IA at the primary side winding wire of the transformer 44 and the current signal IB at the primary side winding wire of the transformer 45.

The addition unit 19 outputs a signal obtained by adding the current signal IA and the current signal IB together. The amplitude detection unit 16 detects the amplitude of a signal output from the addition unit 19, and outputs the detected amplitude to the input layer X1.

The subtraction unit 38 outputs a signal obtained by subtracting the current signal IB from the current signal IA. The amplitude detection unit 17 detects the amplitude of a signal output from the subtraction unit 38, and outputs the detected amplitude to the input layer X2.

The amplitude detection unit 18 detects the amplitude of the current signal IA, and outputs the detected amplitude to the input layer X3 and the upthrust vibration amplitude control unit 30. The input layer X4 receives, as an input, a torque command from the command unit (not illustrated). The input layer X5 receives, as an input, a speed command from the command unit (not illustrated). The output layer Y1 outputs the VB voltage amplitude command to the alternating-current signal generation unit 15.

Then, the alternating-current signal generation unit 15 sets the voltage amplitude of the alternating-current signal VB, so that the speed and torque are controlled according to the magnitude of the amplitude of the vibration in the advancing direction excited at the vibrating body 605.

Moreover, in the fourth exemplary embodiment, in addition to control of the speed and torque, control of the upthrust vibration amplitude is also performed. The amplitude of the current signal IA which the amplitude detection unit 18 outputs represents the upthrust vibration amplitude. The upthrust vibration amplitude control unit 30 compares an upthrust vibration amplitude command received from the command unit (not illustrated) and the amplitude of the current signal IA with each other, generates a frequency command signal in such a manner that the upthrust vibration amplitude command and the amplitude of the current signal IA coincide with each other, and outputs the frequency command signal to the alternating-current signal generation unit 15.

Then, the alternating-current signal generation unit 15 sets frequencies of the alternating-current signals VA and VB according to the frequency command signal, so that the upthrust vibration amplitude is controlled.

Since, when the upthrust vibration amplitude is controlled to be constant, the contact state between the contact body (rotor) 606 and the vibrating body 605 becomes stable, it is possible to increase the stability of control of speed and thrust.

The upthrust vibration amplitude control unit 30 receives, as an input, the detected value of the amplitude of the current signal IA, which is based on a current flowing through the primary side winding wire of the transformer 44, from the amplitude detection unit 18, and thus generates a frequency command. The alternating-current signal generation unit 15 generates the alternating-current signal VA and the alternating-current signal VB based on the frequency command output from the upthrust vibration amplitude control unit 30 and the VB voltage amplitude command output from the output layer Y1.

As described above, according to the above-described first to fourth exemplary embodiments, it is possible to control the speed and thrust (torque) of the vibration-type actuator without the use of a speed detecting sensor and a thrust (torque) detecting sensor.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the present disclosure can also be implemented by a circuit which implements one or more functions of the above-described exemplary embodiments (for example, an application specific integrated circuit (ASIC)).

Furthermore, each of the above-described exemplary embodiments merely represents a specific example in implementing the present disclosure, and should not be construed to limit the technical scope of the present disclosure. Thus, the present disclosure can be implemented in various forms without departing from the technical idea thereof or the principal features thereof.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-091431 filed Jun. 5, 2024, which is hereby incorporated by reference herein in its entirety.

What is claimed is:

1. A control device for a vibration-type actuator including a vibrating body, which includes an elastic body and an electro-mechanical energy conversion element, and a contact body, which is in contact with the elastic body, the contact body being moveable relative to the vibrating body by vibration of the vibrating body which is excited by applying an alternating-current voltage to the electro-mechanical energy conversion element, the control device comprising:
a neural network including
an input layer which receives, as inputs,
a detected value, and
at least one of a command value for a relative speed of the contact body with respect to the vibrating body, and
a command value for a thrust occurring between the vibrating body and the contact body,
an intermediate layer which performs an arithmetic operation according to a signal received from the input layer, and
an output layer which outputs a command for a manipulated variable for the alternating-current voltage,
wherein the detected value is a detected value of a signal related to the alternating-current voltage or a detected value of vibration of the vibrating body.

2. The control device according to claim 1,
wherein the control device further comprises a transformer configured to generate the alternating-current voltage, and
wherein the detected value is a detected value of a signal that is based on a current flowing through a primary side winding wire of the transformer, a detected value of a voltage to be applied to the primary side winding wire of the transformer, or a detected value of an electric power of the primary side winding wire of the transformer.

3. The control device according to claim 1, wherein the input layer receives, as inputs, the detected value, a command value for a relative speed of the contact body with respect to the vibrating body, and a command value for a thrust occurring between the vibrating body and the contact body.

4. The control device according to claim 1,
wherein the control device further comprises:
a first transformer configured to apply a first alternating-current voltage to a first electrode of the electro-mechanical energy conversion element; and
a second transformer configured to apply a second alternating-current voltage to a second electrode of the electro-mechanical energy conversion element,
wherein the output layer outputs a command for a phase difference between a first alternating-current signal to be supplied to a primary side winding wire of the first transformer and a second alternating-current signal to be supplied to a primary side winding wire of the second transformer.

5. The control device according to claim 4, wherein the control device further comprises an alternating-current signal generation unit configured to generate the first alternating-current signal and the second alternating-current signal based on the command for the phase difference.

6. The control device according to claim 4, wherein the input layer receives, as inputs:
a detected value of an amplitude of a signal that is based on a current flowing through the primary side winding wire of the first transformer;
a detected value of an amplitude of a signal that is based on a current flowing through the primary side winding wire of the second transformer;
a detected value of an amplitude of a signal obtained by adding together the signal that is based on a current flowing through the primary side winding wire of the first transformer and the signal that is based on a current flowing through the primary side winding wire of the second transformer;
a command value for a thrust occurring between the vibrating body and the contact body; and
a command value for a relative speed of the contact body with respect to the vibrating body.

7. The control device according to claim 4, wherein the input layer receives, as inputs:
a detected value of an amplitude of a vibration detection signal corresponding to the first electrode of the electro-mechanical energy conversion element;
a detected value of an amplitude of a vibration detection signal corresponding to the second electrode of the electro-mechanical energy conversion element;
a detected value of an amplitude of a signal obtained by adding together the vibration detection signal corresponding to the first electrode of the electro-mechanical energy conversion element and the vibration detection signal corresponding to the second electrode of the electro-mechanical energy conversion element;
a command value for a thrust occurring between the vibrating body and the contact body; and
a command value for a relative speed of the contact body with respect to the vibrating body.

8. The control device according to claim 4, wherein the input layer receives, as inputs:
a detected value of an amplitude of a voltage to be applied to the primary side winding wire of the first transformer;
a detected value of an amplitude of a voltage to be applied to the primary side winding wire of the second transformer;
a detected value of an amplitude of a signal that is based on a current flowing through the primary side winding wire of the first transformer;
a detected value of an amplitude of a signal that is based on a current flowing through the primary side winding wire of the second transformer;
a detected value of an amplitude of a signal obtained by adding together the signal that is based on a current flowing through the primary side winding wire of the first transformer and the signal that is based on a current flowing through the primary side winding wire of the second transformer;
a command value for a thrust occurring between the vibrating body and the contact body; and
a command value for a relative speed of the contact body with respect to the vibrating body.

9. The control device according to claim 4, wherein the input layer receives, as inputs:
a detected value of an electric power of the primary side winding wire of the first transformer;
a detected value of an electric power of the primary side winding wire of the second transformer;
a detected value of an amplitude of a signal obtained by adding together a signal that is based on a current flowing through the primary side winding wire of the first transformer and a signal that is based on a current flowing through the primary side winding wire of the second transformer;
a command value for a thrust occurring between the vibrating body and the contact body; and
a command value for a relative speed of the contact body with respect to the vibrating body.

10. The control device according to claim 9,
wherein the detected value of an electric power of the primary side winding wire of the first transformer is a detected value of an average value of a signal obtained by multiplying a voltage to be applied to the primary side winding wire of the first transformer by a signal that is based on a current flowing through the primary side winding wire of the first transformer, and
wherein the detected value of an electric power of the primary side winding wire of the second transformer is a detected value of an average value of a signal obtained by multiplying a voltage to be applied to the primary side winding wire of the second transformer by a signal that is based on a current flowing through the primary side winding wire of the second transformer.

11. The control device according to claim 4, wherein the input layer receives, as inputs:
a detected value of a phase difference between a voltage obtained by adding together a voltage to be applied to the primary side winding wire of the first transformer and a voltage to be applied to the primary side winding wire of the second transformer and a signal obtained by adding together a signal that is based on a current flowing through the primary side winding wire of the first transformer and a signal that is based on a current flowing through the primary side winding wire of the second transformer;
a detected value of an amplitude of the signal that is based on a current flowing through the primary side winding wire of the first transformer;
a detected value of an amplitude of the signal that is based on a current flowing through the primary side winding wire of the second transformer;
a detected value of an amplitude of the signal obtained by adding together the signal that is based on a current flowing through the primary side winding wire of the first transformer and the signal that is based on a current flowing through the primary side winding wire of the second transformer;
a command value for a thrust occurring between the vibrating body and the contact body; and
a command value for a relative speed of the contact body with respect to the vibrating body.

12. The control device according to claim 1, wherein the input layer receives, as inputs, the detected value, a command value for a relative speed of the contact body with respect to the vibrating body, and a command value for a torque occurring between the vibrating body and the contact body.

13. The control device according to claim 1,
wherein the control device further comprises:
a first transformer configured to apply a first alternating-current voltage to a first electrode of the electro-mechanical energy conversion element; and
a second transformer configured to apply a second alternating-current voltage to a second electrode of the electro-mechanical energy conversion element,
wherein an amplitude of a first alternating-current signal to be supplied to a primary side winding wire of the first transformer is constant, and
wherein the output layer outputs a command for an amplitude of a second alternating-current signal to be supplied to a primary side winding wire of the second transformer.

14. The control device according to claim 13, wherein the control device further comprises an alternating-current signal generation unit configured to generate the second alternating-current signal based on the command for the amplitude of the second alternating-current signal.

15. The control device according to claim 13, wherein the input layer receives, as inputs:
a detected value of an amplitude of a signal obtained by adding together a signal that is based on a current flowing through the primary side winding wire of the first transformer and a signal that is based on a current flowing through the primary side winding wire of the second transformer;
a detected value of an amplitude of a signal obtained by subtracting the signal that is based on a current flowing through the primary side winding wire of the second transformer from the signal that is based on a current flowing through the primary side winding wire of the first transformer;
a detected value of an amplitude of the signal that is based on a current flowing through the primary side winding wire of the first transformer;
a command value for a torque occurring between the vibrating body and the contact body; and
a command value for a relative speed of the contact body with respect to the vibrating body.

16. The control device according to claim 4, wherein the input layer receives, as inputs:
a detected value of an amplitude of a signal that is based on a current flowing through the primary side winding wire of the first transformer;
a detected value of an amplitude of a signal that is based on a current flowing through the primary side winding wire of the second transformer;
a detected value of an amplitude of a signal obtained by adding together the signal that is based on a current flowing through the primary side winding wire of the first transformer and the signal that is based on a current flowing through the primary side winding wire of the second transformer;
a command value for a torque occurring between the vibrating body and the contact body; and
a command value for a relative speed of the contact body with respect to the vibrating body.

17. The control device according to claim 15, wherein the control device further comprises:
a control unit configured to generate a frequency command based on the detected value of the amplitude of the signal that is based on a current flowing through the primary side winding wire of the first transformer, and
an alternating-current signal generation unit configured to generate the first alternating-current signal and the second alternating-current signal based on the command for the amplitude of the second alternating-current signal and the frequency command.

18. The control device according to claim 1, wherein the input layer receives, as inputs, a plurality of time-series values.

19. The control device according to claim 1, wherein the intermediate layer is a recursive connection for returning an output to an input.

20. The control device according to claim 1, wherein the neural network is a trained neural network which is trained by receiving, as inputs, the detected value and at least one of a relative speed of the contact body with respect to the vibrating body and a thrust occurring between the vibrating body and the contact body.
